(19) United States
(12) Patent Application Publication
(10) Pub. No.: US 2011/0157607 A1
(43) Pub. Date: Jun. 30, 2011

(54) IMAGE PROCESSING APPARATUS AND IMAGE FORMATION APPARATUS

(75) Inventor: Daijiro SAITO, Tokyo (JP)

(73) Assignee: KONICA MINOLTA BUSINESS TECHNOLOGIES, INC., Tokyo (JP)

(21) Appl. No.: 12/974,420

(22) Filed: Dec. 21, 2010

(30) Foreign Application Priority Data
Dec. 25, 2009 (JP) 2009-293584

(51) Int. Cl. G06K 15/02

(52) U.S. Cl. 358/1.2

(57) ABSTRACT

An image processing apparatus includes a magnification variation section to perform a magnification variation to image data configured by arranging a plurality of lines in a sub-scan direction perpendicular to a main scan direction, in which a first pixel train is arranged as one of the plurality of lines, by inserting a pixel into a second pixel train in the sub-scan direction or by thinning-out a pixel from the second pixel train based on a set magnification variation ratio, wherein the magnification variation section inserts pixels in adjacent second pixel trains at positions that are discontinuous in the main scan direction, or thin-outs pixels in adjacent second pixel trains at positions that are discontinuous in the main scan direction.

### BACKGROUND OF THE INVENTION

1. Field of the Invention

The present invention relates to an image processing apparatus and an image formation apparatus.

2. Description of the Related Art

In recent years, an image formation apparatus equipped with an exposure apparatus including an optical system, such as a polygon mirror; a development device; a photosensitive drum; and the like has been used. In such an image formation apparatus, the surface of a photosensitive drum is exposed by the deflection scan of a light modulated on the basis of image data by the polygon mirror, which rotates at a predetermined speed, and an electrostatic latent image is formed on the surface. Then, toner adheres to the electrostatic latent image formed on the photosensitive drum to form a toner image. The toner image is transferred onto a sheet of paper, and is subjected to heat fixing by a fixing apparatus. Thus an image is formed on the sheet of paper.

In an image formation apparatus equipped with a polygon mirror to each color to perform exposure by the color, a magnification ratio adjustment in the sub-scan direction is performed to each color by adjusting the rotation speed of the polygon mirror in order to adjust color shifts in the sub-scan direction. If the rotation speed of a polygon mirror is changed, however, a time during which the other operations must be waited until the rotation speed is stabilized becomes necessary, and the image formation apparatus has the problem of the fall of the productivity thereof.

In particular, in case of performing a front-back registration, which accords the positions of images formed on both the surfaces of a sheet of paper with each other on the front and back surfaces, it becomes necessary to change the size of the image formed on the back surface according to the heat shrinkage rate of the sheet of paper because the sheet of paper after the formation of the image on the front surface thereof has thermally shrunken by the heat fixing of the fixing apparatus. At this time, if the image size is changed by changing the rotation speed of the polygon mirror, it is obliged to interrupt the image formation until the rotation speed is stabilized, and the image formation apparatus has the problem of the fall of the productivity thereof.

Moreover, an image formation apparatus that exposes a plurality of colors by means of a single polygon mirror cannot change the rotation speed of the polygon mirror every color, and it is difficult to adjust the magnification ratio in the sub-scan direction every color.

Accordingly, Japanese Patent Application Laid-Open Publication No. 2008-292518 has disclosed the technique of eliminating the need for changing the rotation speed of a rotary polygon mirror, which need accompanies a change of the process speed, by correcting image data according to the process speed to adjust the magnification ratio in the sub-scan direction, in an image formation apparatus that changes the process speed thereof on the basis of the type of the image data between color data and monochrome data.

However, although the image formation apparatus disclosed in Japanese Patent Application Laid-Open Publication No. 2008-292518 can adjust the magnification ratio in the sub-scan direction without changing the rotation speed of the polygon mirror, the image formation apparatus changes the process speed thereof, and consequently the image formation apparatus needs a time until the process speed becomes stable, which makes the productivity thereof not good.

Moreover, if the magnification ratio adjustment in the sub-scan direction is performed by insertion or thinning-out by the line, the magnification ratio adjustment causes the problems of image deteriorations such as a change of an image to the one in which a periodic pattern becomes conspicuous and a change of an image to the one in which a difference in level of the image at a position of the insertion or the thinning-out is conspicuous.

### SUMMARY OF THE INVENTION

The present invention was made in view of the aforesaid situation, and aims to improve the productivity thereof by enabling a magnification ratio adjustment of image data in the sub-scan direction and the prevention of image deteriorations accompanying the magnification ratio adjustment without changing the rotation speed of a polygon mirror.

In order to realize at least one of the aforesaid objects, according to a first aspect of the present invention, there is provided an image processing apparatus including: a magnification variation section to perform a magnification variation to image data configured by arranging a plurality of lines in a sub-scan direction perpendicular to a main scan direction, in which a first pixel train (or pixel row) is arranged as one of the plurality of lines, by inserting a pixel into a second pixel train (or pixel row) in the sub-scan direction or by thinning-out a pixel from the second pixel train based on a set magnification variation ratio, wherein the magnification variation section inserts pixels in adjacent second pixel trains at positions that are discontinuous in the main scan direction, or thin-outs pixels in adjacent second pixel trains at portions that are discontinuous in the main scan direction.

According to a second aspect of the present invention, there is provided an image formation apparatus, including: an image formation section to perform image formation on both sides of a sheet of paper based on image data; a storage section to store magnification variation ratios individually set on a front surface and a back surface of the sheet of paper on which the image formation is performed based on the image data; and the image processing apparatus said above.

### BRIEF DESCRIPTION OF THE DRAWINGS

The present invention will be more fully understood by the following detailed description and the accompanying drawings. However, these are not intended to limit the present invention, in which

FIG. 1 is a functional configuration diagram of an image formation apparatus;

FIG. 2 is a diagram showing an example of a magnification variation ratio table;

FIG. 3 is a schematic configuration diagram of an image processing apparatus;

FIG. 4 is a schematic functional configuration diagram of a memory controller 230 when image data is expanded in a sub-scan direction;

FIG. 5 is a schematic configuration diagram of a magnification variation section shown in FIG. 4;

FIG. 6 flow chart of selection signal generation processing executed by the selection signal generation section;

FIG. 7A is an operation image diagram of output image data in the case where a line counter value is zero at the time of expanding the image data into the sub-scan direction;

FIG. 7B is an operation image diagram of output image data in the case where a line counter value is one at the time of expanding the image data into the sub-scan direction;

FIG. 7C is an operation image diagram of output image data in the case where a line counter value is two at the time of expanding the image data into the sub-scan direction;

FIG. 7D is an operation image diagram of output image data in the case where a line counter value is equal to an insertion period at the time of expanding the image data into the sub-scan direction;

FIG. 7E is an operation image diagram of output image data in the case where a line counter value is reset after the operation of FIG. 7D (in the case where the line counter value is zero);

FIG. 8A is an image diagram of the whole output image based on the output image data when the image data is expanded into the sub-scan direction as shown in FIGS. 7A-7E;

FIG. 8B is a partially expanded image diagram of the output image shown in FIG. 8A;

FIG. 9 is a schematic configuration diagram of a magnification variation section in the case of multiple-value image data;

FIG. 10 is a flow chart of selection signal generation processing executed by the selection signal generation section;

FIG. 11 is a partially expanded image diagram of an output image based on the output image data when the multiple-value image data is expanded into the sub-scan direction;

FIG. 12 is a schematic functional configuration diagram of the memory controller when image data is expanded in the sub-scan direction;

FIG. 13 is a schematic configuration diagram of a pixel thinning-out section shown in FIG. 12;

FIG. 14 is a flow chart of selection signal generation processing executed by the selection signal generation section;

FIG. 15A is an operation image diagram of output image data in the case where a line counter value is one at the time of reducing the image data into the sub-scan direction;

FIG. 15B is an operation image diagram of output image data in the case where a line counter value is two at the time of reducing the image data into the sub-scan direction;

FIG. 15C is an operation image diagram of output image data in the case where a line counter value is three at the time of reducing the image data into the sub-scan direction;

FIG. 15D is an operation image diagram of output image data in the case where a line counter value is 99 at the time of reducing the image data into the sub-scan direction;

FIG. 15E is an operation image diagram of output image data in the case where a line counter value is equal to the thinning-out period at the time of reducing the image data into the sub-scan direction;

FIG. 15F is an operation image diagram of output image data in the case where the line counter value is reset after the operation of FIG. 15E;

FIG. 16 is a partially expanded image diagram of the output image based on output image data when the image data is reduced in the sub-scan direction as shown in FIGS. 15A-15F;

FIG. 17 is a schematic functional configuration diagram of an output image memory controller when image data is reduced in the sub-scan direction; and

FIG. 18 is a schematic configuration diagram of a magnification variation section shown in FIG. 17.

### DETAILED DESCRIPTION OF THE PREFERRED EMBODIMENTS

In the following, the present embodiment will be described in detail with reference to the accompanying drawings.

First, the configuration thereof will be described.

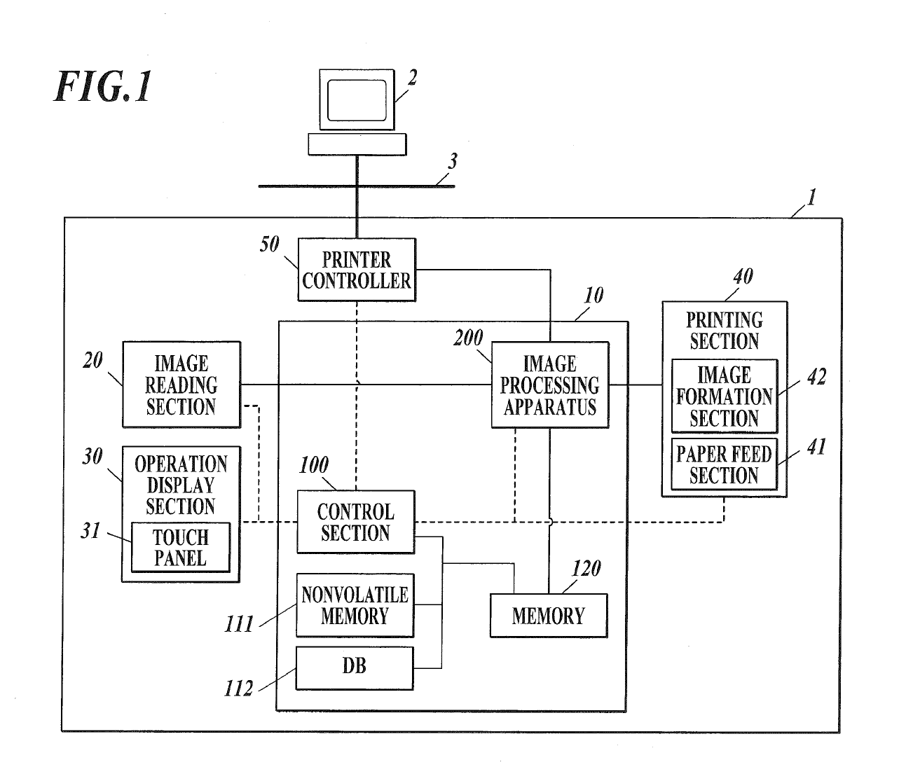

FIG. 1 shows a functional configuration diagram of an image formation apparatus 1 according to the present embodiment.

As shown in FIG. 1, the image formation apparatus 1 is composed of a main body control section 10, an image reading section 20, an operation display section 30, a printing section 40, a printer controller 50, and the like.

The main body control section 10 is equipped with a control section 100, a nonvolatile memory 111, a data base (DB) 112, a memory 120, an image processing apparatus 200, and the like, and each section is collectively controlled by the control section 100.

The control section 100 is composed of a central processing unit (CPU), a read only memory (ROM), a random access memory (RAM), and the like. The control section 100 reads out a designated program and data among a system program, various application programs, and various pieces of data, which are stored in the ROM, the nonvolatile memory 111, or the DB 112, and develops the read-out program and data in the RAM. The control section 100 executes various pieces of processing in cooperation with the developed programs, and the control section 100 performs the centralized control of each section of the image formation apparatus 1. For example, the control section 100 changes a copy mode, a printer mode, and a scanner mode to perform the control of copying, printing, and reading of image data, and the like, in conformity with an instruction signal input from an external apparatus 2 connected to the main body control section 100 through the operation display section 30 and the printer controller 50.

Moreover, the control section 100 reads out a processing program according to the present embodiment and necessary pieces of data from the ROM or the nonvolatile memory 111, and controls image formation processing in cooperation with the program and the various pieces of data.

If the control section 100 in the present embodiment executes image formation processing for forming an image on a sheet of paper on the basis of image data, the control section 100 refers to a magnification variation ratio table in the nonvolatile memory 111, and selects a magnification variation ratio corresponding to the type and the size of the sheet of paper on which an image is formed on the basis of the image data, and the printing mode (both sides/one side). Then, the control section 100 calculates a magnification variation period (insertion period or thinning-out period) for performing the insertion or thinning-out of a pixel into the sub-scan direction on the basis of the magnification variation ratio, and outputs a magnification variation period signal (insertion period signal or thinning-out period signal) indicating the magnification variation period to the image processing apparatus 200.

For details, the control section 100 multiplies a magnification variation ratio by each color shift correction magnification ratio, and the control section 100 calculates a magnification variation quantity (the number of pixels to be expanded or reduced in the sub-scan direction) in the sub-scan direction on the basis of the multiplied value. Then, the control section 100 calculates the number of pixels obtained by dividing the number of pixels of image data in the sub-scan direction into two equal parts according to the magnification variation quantity as a magnification variation period (insertion period or thinning-out period).

For example, if the number of pixels in the sub-scan direction is 1,000 pixels, and if the multiplied value is 101%, then the control section 100 judges expansion into the sub-scan direction because the multiplied value is equal to or more than 100%. The control section 100 then calculates 10 pixels as a magnification variation quantity and 100 pixels as an insertion period, and outputs an insertion period signal. Moreover, for example, if the number of pixels in the sub-scan direction is 1,000 pixels, and if the multiplied value is 99%, then the control section judges reduction into the sub-scan direction because the multiplied value is less than 100%. The control section 100 then calculates 10 pixels as a magnification variation quantity and 100 pixels as a thinning-out period, and outputs a thinning-out period signal.

The nonvolatile memory 111 stores a processing programs of the present embodiment, various pieces of data generated in each piece of processing, processed data, and the like, besides various processing programs and data for image formation. Moreover, the nonvolatile memory 111 of the present embodiment functions as a storage section for storing a magnification variation ratio table.

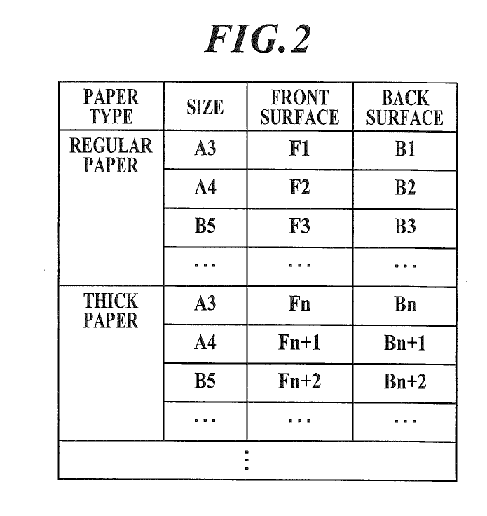

FIG. 2 shows an example of a magnification variation ratio table.

As shown in FIG. 2, in the magnification variation ratio table, magnification variation ratios in the sub-scan direction are set on the basis of the type (paper type) and size of each sheet of paper, and heat shrinkage rate of each of the front surface and back surface of each sheet of paper.

In addition, the magnification variation ratio table may also includes magnification variation ratios in the sub-scan direction, each set to each paper feed tray provided in the paper feed section 41 of the printing section 40 on the basis of the heat shrinkage rate of each sheet of paper stored in the paper feed tray. Furthermore, the magnification variation ratio table may be rewritable in conformity with an instruction from the operation display section 30.

The DB 112 is composed of a writable nonvolatile storage medium, such as a hard disk drive (HDD).

The memory 120 is composed of a hard disk drive (HDD), a dynamic random access memory (DRAM) and the like, and readably and writably stores image data. The image data stored in the memory 120 is configured to include a plurality of lines arranged in the sub-scan direction perpendicular to the main scan direction, each line being a pixel train arranged in the main scan direction.

The memory 120 memorizes the image data input from the image reading section 20 or the printer controller 50 and processed by the image processing apparatus 200, and stores the image data in conformity with an instruction from the control section 100. The image data stored in the memory 120 is read out to be output to the image processing apparatus 200.

The image processing apparatus 200 performs various pieces of image processing to the image data input from the image reading section 20, the printer controller 50, or the memory 120, and outputs the processed image data to the memory 120 or the printing section 40.

The image reading section 20 is composed of a charge coupled device (CCD), an image reading control section, an automatic original sending section called an auto document feeder (ADF), a reading section, and the like. The image reading control section controls the automatic original sending section, the reading section, and the like, on the basis of an instruction from the control section 100, and reads the images of a plurality of originals. The read analog image data is output to the image processing apparatus 200. Here, the image includes not only image data, such as a figure and photograph, but also text data, such as a character and a mark.

The operation display section 30 is equipped with a display section, such as a liquid crystal display (LCD), and an input section composed of a touch panel 131 provide to cover the display section, a start button, an operation display control section, and the other not-shown operation keys. The operation display section 30 outputs operation signals input from an operation key group or the touch panel 131 to the control section 100. Moreover, the operation display section 30 displays various setting screens for inputting various setting conditions, various processing results, and the like in conformity with display signals input from the control section 100 through the operation display control section.

The printing section 40 performs the image formation processing of an electrophotographic printing system on the basis of printing data input from the image processing apparatus 200. The printing section 40 is composed of each section pertaining to printing output, such as the paper feed section 41, the fed paper conveyance section, the image formation section 42 of each color, a fixation section, and a carrying-out section, and a printing control section.

The paper feed section 41 is equipped with a plurality of paper feed trays. Each of the paper feed trays stores sheets of paper previously identified by every type of paper (paper type, basis weight, size). Every sheet is conveyed to the fed paper conveyance section from the uppermost part of the sheets of paper one by one.

The fed paper conveyance section conveys a sheet of paper conveyed from the paper feed tray to a secondary transfer roller through a plurality of intermediate rollers, a resist roller, and the like. Moreover, the fed paper conveyance section conveys a sheet of paper subjected to image formation processing on one side thereof to a both-side conveyance path with a conveyance path switching plate, and again conveys the sheet of paper to the secondary transfer roller through the intermediate rollers and the resist roller. By the secondary transfer roller, toner images transferred on an intermediate transfer belt, which will be described below, are collectively transferred on a sheet of paper.

The image formation section 42 is equipped with the photosensitive drum, the charging apparatus, the exposure apparatus, the development device, a primary transfer roller, a cleaning apparatus, and the like. The image formation section 42 produces an output material, which is a sheet of paper on which an image is formed on the basis of image data. For example, if the image formation apparatus 1 is one forming a color image, the image formation section 42 is provided to each color.

For example, an image formation section for forming a yellow (Y) image is equipped with a charging apparatus, an exposure apparatus, a development device, a primary transfer roller, and a cleaning apparatus, all arranged around a photosensitive drum, and forms a yellow (Y) image.

To put it concretely, a light according to yellow (Y) image data is radiated from the exposure apparatus onto the photosensitive drum charged by the charging apparatus, and an electrostatic latent image is formed. A yellow (Y) toner is packed in the development device, and the development device makes the toner adhere to the surface of the photosensitive drum, on which the electrostatic latent image is formed, to develop the electrostatic latent image. The toner made to adhere to the photosensitive drum moves to a transfer position where the primary transfer roller is arranged by the rotation of the photosensitive drum at a constant speed, and the toner is transferred to the intermediate transfer belt at the transfer position. After the toner has been transferred to the intermediate transfer belt, the cleaning apparatus removes residual charges and residual toner on the surface of the photosensitive drum.

Similarly, the image formation section of each color is equipped with a charging apparatus, an exposure apparatus, a development device, a primary transfer roller, and a cleaning apparatus, all arranged around a photosensitive drum. The image formation sections forms images of magenta (M), cyan (C), and black (K), respectively.

The toner of each color transferred on the intermediate transfer belt at the transfer position by each primary transfer roller is collectively transferred to a sheet of paper at a transfer position by the secondary transfer roller.

The toner image transferred to the sheet of paper is thermally fixed by the fixing apparatus, and the sheet of paper on which the image is formed by thermally fixing the toner image is ejected to a copy receiving tray through a carrying-out port with being nipped by paper ejection rollers.

When image formation is performed on both the sides of a sheet of paper, the sheet of paper ejected from the fixing apparatus after being subjected to image formation on one surface (for example, on front surface) thereof, is conveyed to the both-side conveyance path with the conveyance path switching plate, and is again conveyed to the secondary transfer roller through the intermediate rollers. Then, image formation is performed on the other surface (back surface) thereof. Consequently, the image formation section 42 realizes the function of performing image formation on both sides of a sheet of paper on the basis of image data.

The printer controller 50 performs the management and the control of jobs transmitted from the external apparatus 2, such as a personal computer (PC) connected to a network 3, such as a local area network (LAN), to the image formation apparatus 1 when the image formation apparatus 1 is used as a network printer. The printer controller 50 receives the data of a printing object from the external apparatus 2, and outputs the received data to the control section 100 as job data.

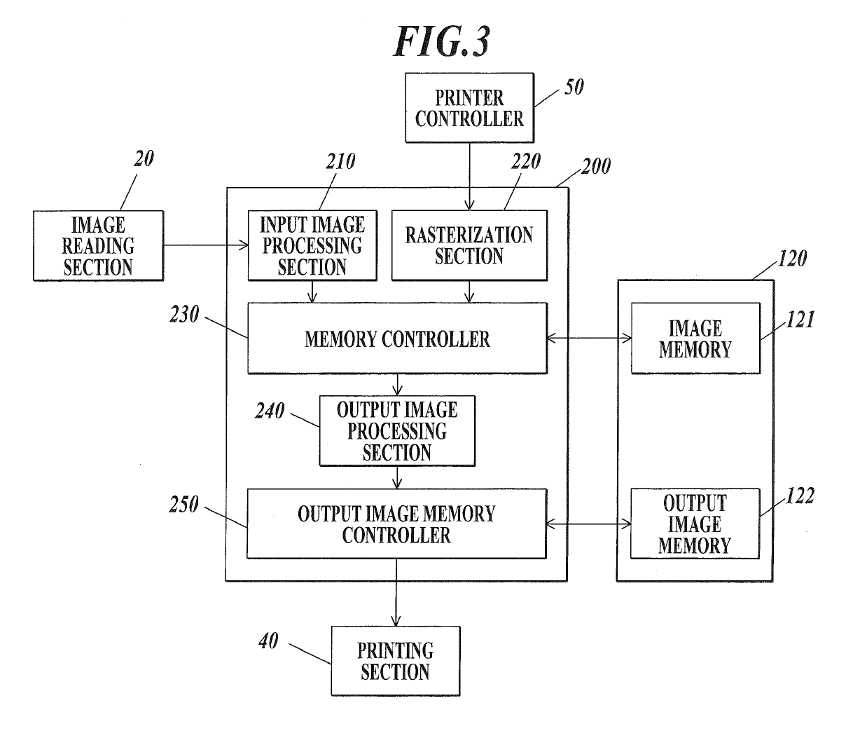

FIG. 3 shows a schematic configuration diagram of the image processing apparatus 200.

As shown in FIG. 3, the memory 120 is equipped with an image memory 121 and an output image memory 122. The image processing apparatus 200 is equipped with an input image processing section 210, a rasterization section 220, a memory controller 230, an output image processing section 240, an output image memory controller 250, and the like.

The image memory 121 performs the writing/reading of image data in conformity with an instruction from the memory controller 230. The output image memory 122 performs the writing/reading of image data in conformity with an instruction from the output image memory controller 250.

In addition, the image memory 121 and the output image memory 122 are provided to each image formation section, that is, to each color of images formed by the image formation section.

The input image processing section 210 performs the analog processing, the analog-to-digital (A/D) conversion processing, the color conversion processing, the luminance-density conversion processing, the filter processing, and the like of analog image data input from the image reading section 20, and outputs the image data subjected to the various pieces of processing to the memory controller.

The rasterization section 220 converts (rasterizes) image data in a page description language (PDL) form, the image data input from the printer controller 50, into image data in a bit map form. The rasterization section 220 outputs the converted image data to the memory controller.

The memory controller 230 is provided at the subsequent stage of the input image processing section 210 and the rasterization section 220 and at the preceding stage of the output image processing section 240.

The memory controller 230 performs the control of writing the image data input from the input image processing section 210 or the rasterization section 220 into the image memory 121 to store the image data therein, or of reading out the image data stored in the image memory 121 to output the read-out image data to the output image processing section 240, in conformity with an instruction from the control section 100.

Moreover, the memory controller 230 of the present embodiment is equipped with a magnification variation section performing the insertion or the thinning-out of a pixel in a pixel train in the sub-scan direction to image data on the basis of a magnification variation period (insertion period or thinning-out period) input from the control section 100, and thereby performing the magnification variation (expanding or reducing) of the image data in the sub-scan direction. The magnification variation section varies the phases of a period pattern of the insertion or the thinning-out of a pixel every pixel train in the sub-scan direction, which insertion or thinning-out is implemented at every magnification variation period, and performs the insertion or the thinning-out of pixels in adjacent pixel trains in the sub-scan direction at positions that are discontinuous in the main scan direction.

The output image processing section 240 performs the screen processing, the error diffusion processing, and the like of the image data input from the memory controller 230, and outputs the image data subjected to the various pieces of processing to the output image memory controller 250. That is, the output image processing section 240 functions as a screen processing section to perform the screen processing of image data.

The output image memory controller 250 performs output timing control of writing the image data input from the output image processing section 240 into the output image memory 122 to store the image data therein, or of outputting the image data stored in the output image memory 122 in synchronization with the operation timing of the printing section 40, in conformity with an instruction from the control section 100.

The image data of each color output from the output image memory controller 250 is output to the image formation section of each color of the printing section 40 as printing data.

In addition, the memory controller 230, the output image processing section 240, and the output image memory controller 250 are provided to each image formation section, that is, to each color of images formed by the image formation section, and treat the image data of each color.

First, the case of expanding image data in the sub-scan direction will be described.

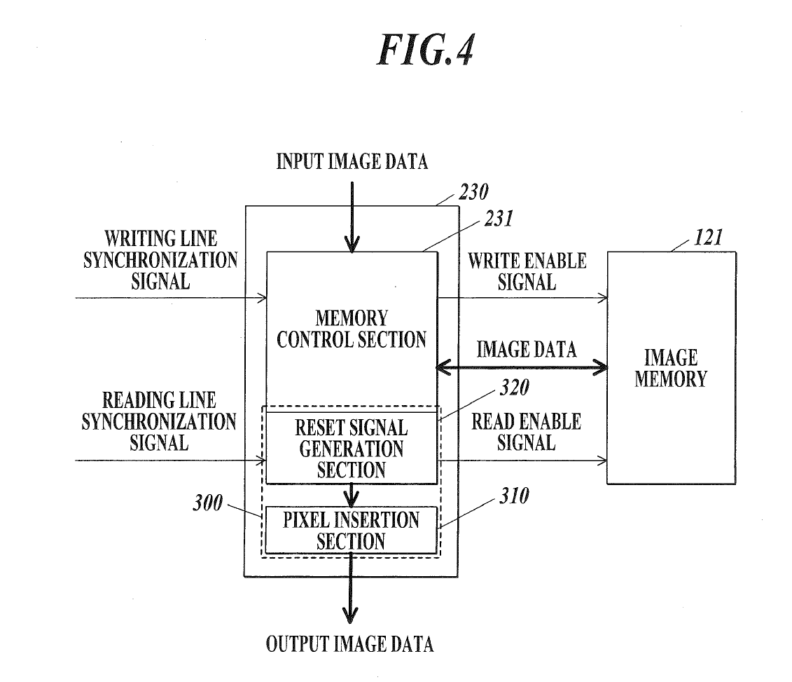

FIG. 4 shows a schematic functional configuration diagram of the memory controller 230 in the case of expanding image data into the sub-scan direction. As shown in FIG. 4, the memory controller 230 is equipped with a memory control section 231 and a magnification variation section 300.

The memory control section 231 generates a write enable signal in conformity with a writing line synchronization signal input from the control section 100. The write enable signal is an enabling signal enabling the input of image data into the image memory 121. The memory control section 231 outputs the write enable signal to the image memory 121, and writes input image data into the image memory 121 to store the image data therein on the basis of the output of the write enable signal.

Moreover, the memory control section 231 generates a read enable signal in conformity with a reading line synchronization signal input from the control section 100. The read enable signal is an enable signal enabling the output of image data to the image memory 121. The memory control section 231 outputs the read enable signal to the image memory 121, and reads out image data stored in the image memory 121 to output the read-out image data on the basis of the output of the read enable signal.

The magnification variation section 300 is provided at the position of an input/output section of the image data to the image memory 121 in the memory controller 230, and is equipped with a pixel insertion section 310 and a reset signal generation section 320. The magnification variation section 300 stops the output of the read enable signal, and performs the insertion of a pixel into each pixel train in the sub-scan direction.

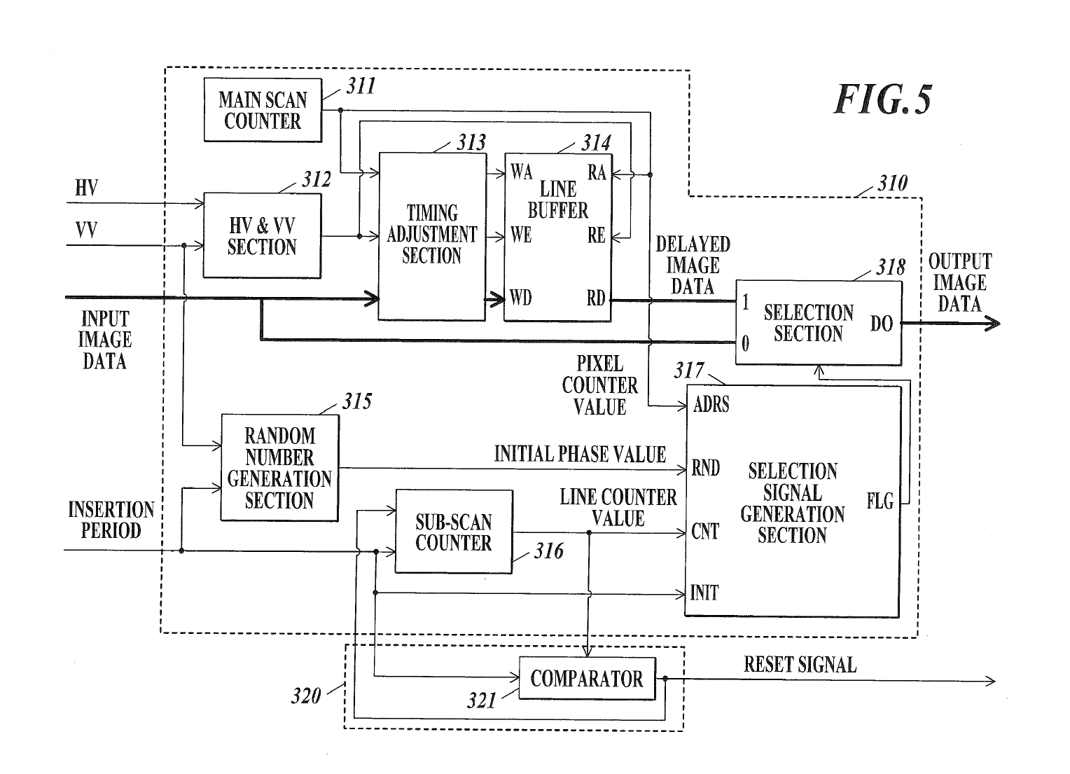

FIG. 5 shows a schematic configuration diagram of the magnification variation section 300 shown in FIG. 4.

The magnification variation section 300 shown in FIG. 5 is an example of the case where image data is binary. As shown in FIG. 5, the magnification variation section 300 is equipped with the pixel insertion section 310 and the reset signal generation section 320.

The pixel insertion section 310 is equipped with a main scan counter 311, an HV & VV section 312, a timing adjustment section 313, a line buffer 314, a random number generation section 315, a sub-scan counter 316, a selection signal generation section 317, and a selection section 318.

The main scan counter 311 is a counter generating a clock signal and counting the number of pixels in the main scan direction. The counter value (pixel counter value: ADRS) by the main scan counter 311 is output to the timing adjustment section 313, the line buffer 314, and the selection signal generation section 317.

A vertical valid (VV: vertical image valid region) signal and a horizontal valid (HV: horizontal image valid region) signal, both generated by the printing control section, are input into the HV & VV section 312 on the basis of a signal from the control section 100. The HV & VV section 312 synthesizes an HV signal and a VV signal, and outputs the synthesized signal to the timing adjustment section 313.

The timing adjustment section 313 performs the timing adjustment between the image data (input image data) read-out from the image memory 121, and each of the HV signal, the VV signal, and the pixel counter value. The timing adjustment section 313 receives the input of a pixel counter value from the main scan counter 311, the input of a synthesized signal of an HV signal and a VV signal from the HV & VV section, and the input of image data read-out from the image memory 121, and outputs each signal after timing adjustment to the line buffer 314.

The line buffer 314 is a buffer storing image data of a pixel train (for one line) in the main scan direction. The line buffer 314 temporarily stores the input image data for one line in the preceding line by one line in the sub-scan direction to the input image data for one line input into the timing adjustment section 313.

The random number generation section 315 receives the VV signal and the insertion period signal. The random number generation section 315 functions as an initial phase output section, which generates a random number within the range of an insertion period indicated by the insertion period signal to each pixel train in the sub-scan direction and outputs the generated random number to the selection signal generation section 317 as an initial phase value (RND) of the periodic pattern of each pixel train in the sub-scan direction.

In addition, although the random number generation section 315 is used in the present embodiment, the present invention is not limited to use the random number generation section 315. In place of the random number generation section 315, the present invention can use the configuration of being equipped with an initial phase storage section to store initial phase setting information, indicating the initial phase value of the periodic pattern of each pixel train in the sub-scan direction, every insertion period, and of selecting the initial phase setting information corresponding to the input insertion period, and further of outputting the initial phase value of the periodic pattern of each pixel train in the sub-scan direction to the selection signal generation section 317 on the basis of the selected initial phase setting information.

Moreover, the random number generation section 315 may be configured to generate a random number within the range of the insertion period indicated by an insertion period signal to each pixel train in the sub-scan direction every input of a reset signal when the reset signal is input from a comparator 321, and to vary the initial phase value of the periodic pattern of the pixel train in the sub-scan direction every insertion period.

The sub-scan counter 316 is a counter generating a clock signal and counting the number of pixels in an insertion period in the sub-scan direction from zero on the basis of a magnification variation ratio.

The sub-scan counter 316 receives the input of an insertion period signal from the control section 100 and the input of a reset signal from the comparator 321, and outputs a counter value (line counter value: CNT) of the number of pixels in the insertion period to the selection signal generation section 317 and the comparator 321. Moreover, when a reset signal is input into the sub-scan counter 316, the sub-scan counter 316 resets the line counter value.

The selection signal generation section 317 receives of the inputs of a pixel counter value from the main scan counter 311, an initial phase value from the random number generation section 315, a line counter value from the sub-scan counter 316, and an insertion period signal from the control section 100. The selection signal generation section 317 compares the line counter value (CNT) and the initial phase value every pixel indicated by the pixel counter value on the basis of the input pixel counter value, the initial phase value, the line counter value, and the insertion period signal. Then, the selection signal generation section 317 generates a selection signal FLG indicating whether to select the image data stored in the line buffer 314 or not to each pixel indicated by the pixel counter value according to the comparison result, and outputs the selection signal FLG to the selection section 318.

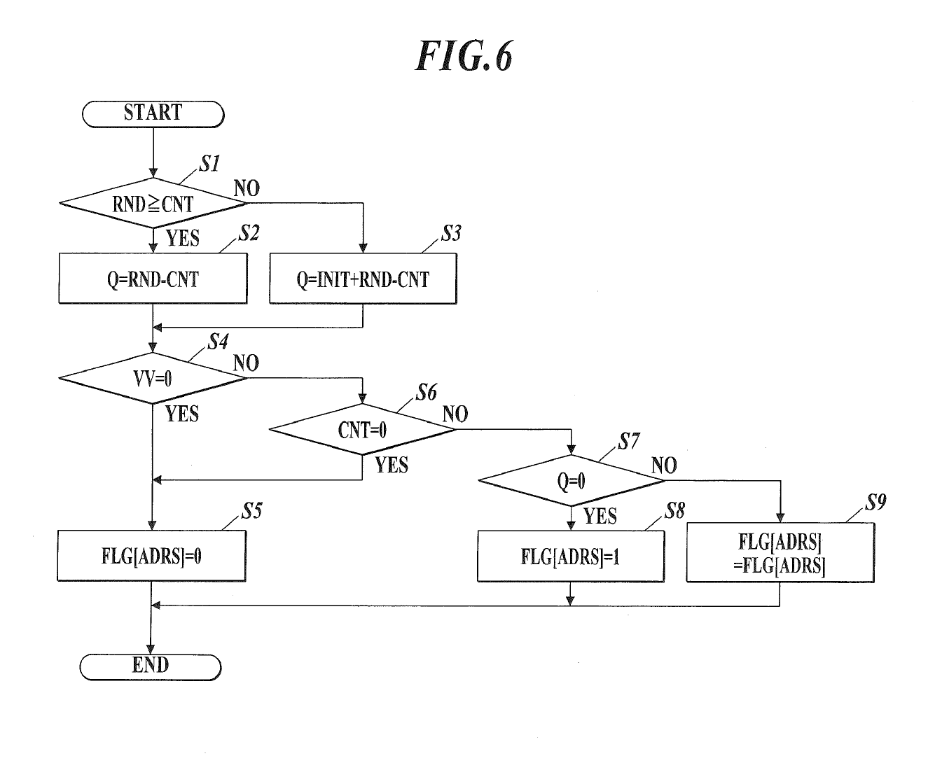

FIG. 6 shows the flow chart of the selection signal generation processing executed by the selection signal generation section 317. In addition, the selection signal generation processing shown in FIG. 6 is executed every input of a pixel counter value ADRS.

First, the selection signal generation section 317 judges whether an initial phase value RND is equal to or more than a line counter value CNT or not (Step S1). If the initial phase value RND is equal to or more than the line counter value CNT (Step S1: YES), the selection signal generation section 317 calculates a value obtained by subtracting the line counter value CNT from the initial phase value RND as a variable Q (Step S2).

If the initial phase value RND is less than the line counter value CNT (Step S1: NO), the selection signal generation section 317 calculates a value obtained by subtracting the line counter value CNT from the sum of the insertion period INIT and the initial phase value RND as the variable Q (Step S3).

Next, the selection signal generation section 317 judges whether the VV signal is zero or not (Step S4). If the VV signal is zero, that is, if the pixel is out of the imaging region (Step S4: YES), the selection signal generation section 317 sets the selection signal FLG [ADRS] of the input pixel counter value ADRS to zero (Step S5), and the selection signal generation section 317 ends the selection signal generation processing.

If the VV signal is not zero, that is, if the VV signal is one (Step S4: NO), the selection signal generation section 317 judges that the pixel is within the imaging region, and the selection signal generation section 317 judges whether the line counter value CNT is zero or not (Step S6). If the line counter value CNT is zero (Step S6: YES), the selection signal generation section 317 executes the processing at Step S5.

If the line counter value CNT is not zero (Step S6: NO), the selection signal generation section 317 judges whether the variable Q is zero or not (Step S7). If the variable Q is zero (Step S7: YES), the selection signal generation section 317 sets the selection signal FLG [ADRS] of the input pixel counter value ADRS to one (Step S8), and the selection signal generation section 317 ends the selection signal generation processing.

If the variable Q is not zero (Step S7: NO), the selection signal generation section 317 keeps the selection signal FLG [ADRS] of the input pixel counter value ADRS to the set selection signal (Step S9), and the selection signal generation section 317 ends the selection signal generation processing.

The selection section 318 receives the inputs of the image data (input image data) read-out from the image memory, the image data (delayed image data) output from the line buffer 314, and the selection signal generated by the selection signal generation section 317. The selection section 318 selects any one of the input image data input from the image memory and the delayed image data input from the line buffer 314 according to an input selection signal to each pixel corresponding to the pixel counter value.

The selection section 318 of the present embodiment is set to select the input image data input from the image memory when the selection signal is zero, and to select the delayed image data input from the line buffer when the selection signal is one.

The reset signal generation section 320 is equipped with the comparator 321.

The comparator 321 receives the inputs of the insertion period signal from the control section 100 and the line counter value from the sub-scan counter 316. The comparator 321 functions as an input control section of comparing the insertion period and the line counter value, generating a reset signal according to the comparison result, and outputting the reset signal to the image memory 121 and the sub-scan counter 316 to control the input and the output of image data in the main scan direction.

The reset signal functions as a signal stopping the output of the read enable signal, for reading out the image data from the image memory every line, for one line when the reset signal is input into the image memory 121, to stop the reading-out of the image data in the main scan direction for one line from the image memory 121. In the present embodiment, the reset signal is generated when the insertion period and the line counter value are equal to each other.

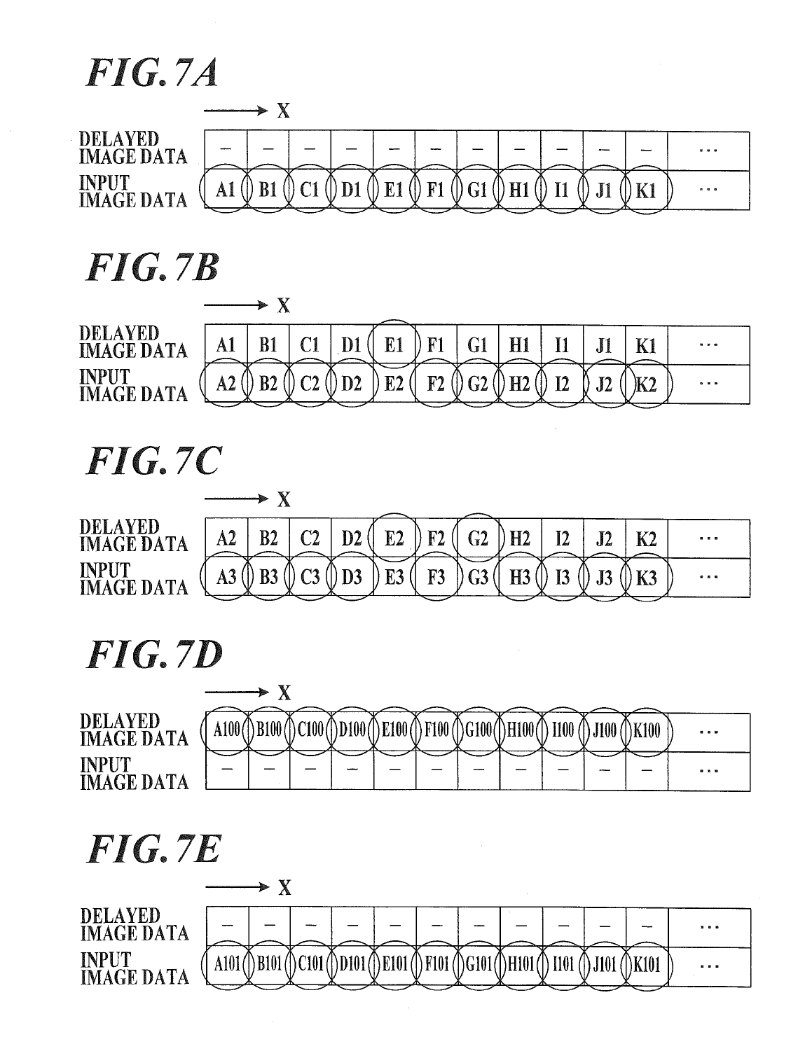

FIGS. 7A-7E show operation image diagrams of output image data when image data is expanded into the sub-scan direction.

FIGS. 7A-7E show the delayed image data for one line output from the line buffer to the selection section 318, and the input image data for one line output from the image memory to the selection section 318. A, B, C, . . . shown in FIGS. 7A-7E are identification marks of the pixels in the main scan direction, and 1, 2, 3, . . . are identification marks (line numbers) of the pixels in the sub-scan direction. The pixels enclosed by circles indicate the pixels selected by the selection section 318 and to be output as output image data.

FIG. 7A shows an operation image diagram of the output image data when the line counter value is zero. As shown in FIG. 7A, because the line buffer 314 is in the state of having no delayed image data therein, no delayed image data is output from the line buffer (denoted by “-” in FIG. 7A). The input image data at a first line is output from the image memory.

Because the line counter value is zero, the selection signals FLG to all the pixels in the main scan direction are set to zero. Consequently, the pixels in the first line of the input image data output from the image memory are selected as the pixels of the first line of output image data.

FIG. 7B shows an operation image diagram of the output image data when the line counter value is one. As shown in FIG. 7B, the input image data at the first line is output from the line buffer 314, and the input image data at a second line is output from the image memory.

For example, if the pixel counter value is E, the initial phase value is two, and the line counter value is two, then the selection signal FLG is set to one to the pixel counter value E. The pixel E1 of the delayed image data (input image data at the first line) is led to be selected as the pixel E of the output image data at the second line. Here, by the selection of the pixel E1 of the input image data at the first line as the pixel E of the output image data at the second line, the same pixel (E1) is led to be output two times continuously in the sub-scan direction, and the column of the pixel E results in being subjected to the insertion of one pixel in the sub-scan direction.

Moreover, because the selection signals FLG of the other pixel counter values are kept, the pixels of the input image data (the input image data at the second line) output from the image memory are led to be selected as the pixels of the output image data excluding E at the second line.

FIG. 7C shows the operation image diagram of the output image data in the case where the line counter value is two. As shown in FIG. 7C, the input image data at the second line is output from the line buffer, and the input image data at a third line is output from the image memory.

For example, if the pixel counter value is G, the initial phase value is three, and the line counter value is three, then the selection signal FLG is set to one to the pixel counter value G, and the pixel G2 of the delayed image data (the input image data at the second line) is led to be selected as the pixel G of the output image data at the third line. Here, by the selection of the pixel G2 of the input image data at the second line as the pixel G of the output image data at the third line, the same pixel (G2) is led to be output two times into the sub-scan direction, and the column of the pixel G is led to be subjected to the insertion of one pixel in the sub-scan direction.

In addition, because the selection signal FLG to the pixel counter value E is kept, the pixel E2 of the delayed image data (the input image data at the second line) is led to be selected as the pixel E of the output image data at the third line.

Moreover, because the selection signals FLG to the pixel counter values of the pixels excluding the pixels E and G are kept, the pixels of the input image data (the input image data at the third line) output from the image memory are led to be selected as the pixels excluding the E and G of the output image data at the third line.

After that, the pixels selecting the delayed image data output from the line buffer 314 increase line by line.

FIG. 7D shows the operation image diagram of the output image data when the line counter value is equal to the insertion period (for example, 100).

If the line counter value becomes equal to the insertion period (for example, 100), a reset signal is input into the image memory. Consequently, the image data in the line next to the insertion period (for example, 101) is not read-out from the image memory, and the selection section 318 is put in the state in which no input image data is input to the selection section 318 from the image memory. Consequently, as shown in FIG. 7D, the input image data at the 100^{th} line is output from the line buffer, but no image data is output from the image memory (denoted by “-” in FIG. 7D).

In this case, all of the pixels of the delayed image data (the input image data at the 100^{th} line) output from the line buffer 314 are led to be selected as all of the pixels of the output image data at he 101^{st} line. Consequently, even if the magnification variation section 300 is in the state in which no input image data is output from the image memory, there are no chances of lacking the output image data.

Moreover, when the line counter value becomes equal to the insertion period (for example 100), a reset signal is input into the sub-scan counter, and the line counter value is reset.

FIG. 7E shows an operation image diagram of the output image data when the line counter value is reset (when the line counter value is zero) after FIG. 7D. As shown in FIG. 7E, because the line buffer 314 is in the state of holding no delayed image data therein, no image data is output from the line buffer 314 (denoted by “-” in FIG. 7E). The input image data at the 101^{st} line is output from the image memory.

Because the line counter value is zero, the selection signals FLG to all of the pixels in the main scan direction are set to zero. Consequently, the pixels of the input image data at the 101^{st} line output from the image memory are selected as the pixels of the output image data at a 102^{nd} line.

After that, the operations as shown in FIGS. 7B-7D are repeated.

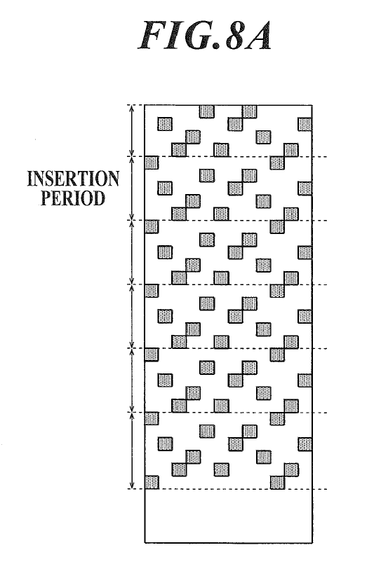

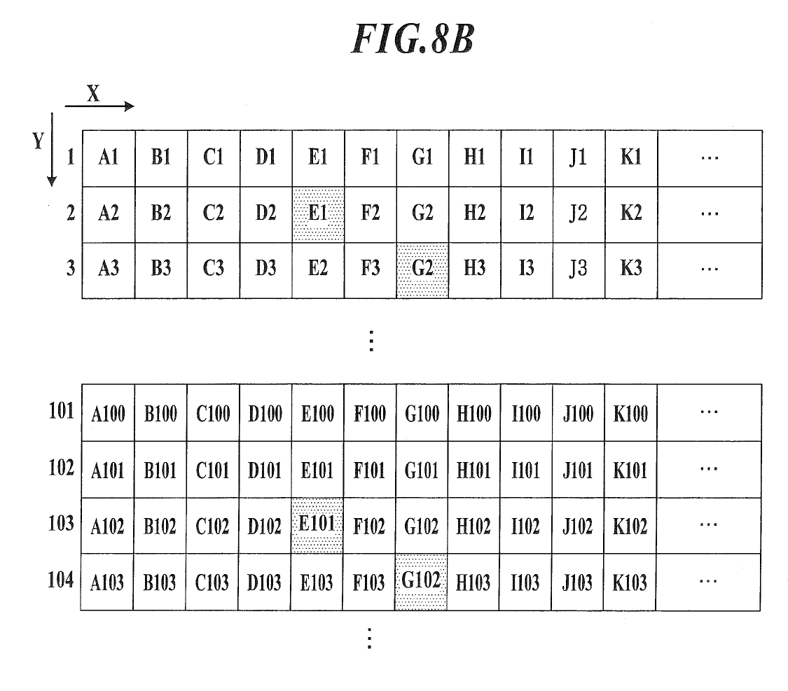

FIG. 8A shows an image diagram of the whole output image based on the output image data when the image data is expanded in the sub-scan direction as shown in FIGS. 7A-7E, and FIG. 8B shows partially expanded image diagram of the output image shown in FIG. 8A.

The marks shown in FIG. 8B are ones for identifying the respective pixels shown in FIGS. 7A-7E, and the line numbers of output image are shown in the sub-scan direction Y. Each of the pixels subjected to half-tone dot meshing shows the preceding pixel in the sub-scan direction Y by one line that is continuously output, that is, an inserted pixel.

As shown in FIGS. 8A and 8B, the insertion of pixels in adjacent pixel trains in the sub-scan direction Y is performed at positions that are discontinuous in the main scan direction X, and is executed at each insertion period by an operation of the magnification variation section. This is because the initial phase values generated by the random number generation section 315 are different at every pixel counter value and the initial phase of the insertion period of a pixel train in the sub-scan direction Y is different from those of the insertion periods of the other pixel trains in the sub-scan direction Y.

Although the magnification variation section 300 shown in FIG. 5 sets the image data of the preceding pixel by one in the sub-scan direction as the image data of the pixel to be inserted, the present invention is not limited to this method, but the image data of the pixel to be inserted may be generated by the use of an image interpolation method, such as the nearest neighbor method, to a pixel train in the sub-scan direction.

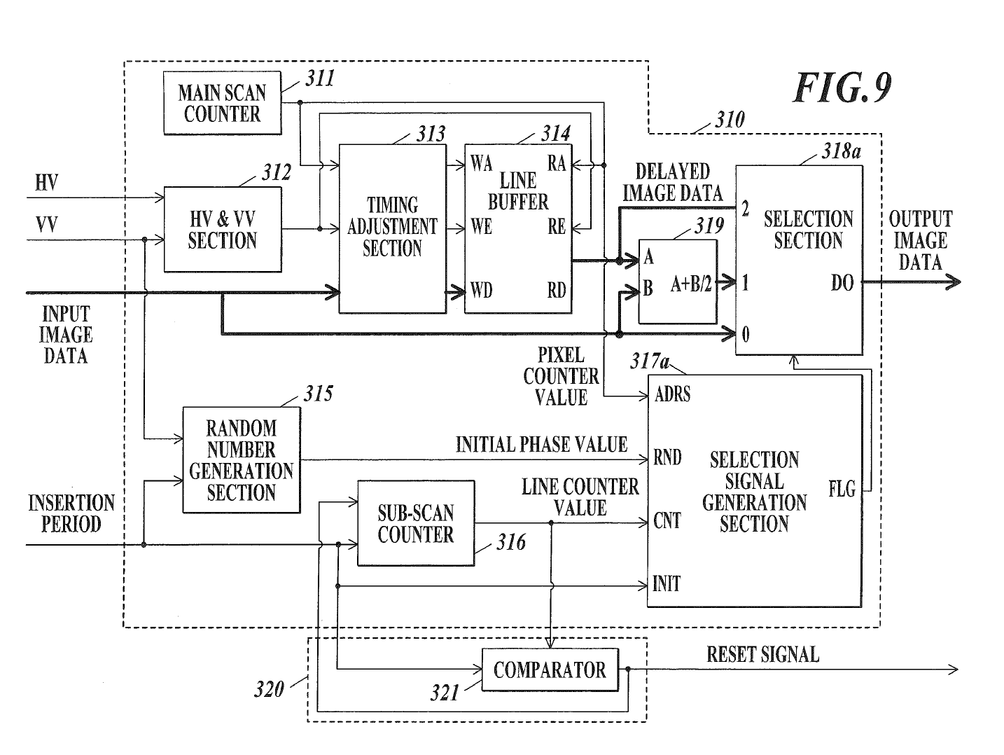

FIG. 9 shows the schematic configuration diagram of the magnification variation section 300 in the case of multiple-value image data.

In addition, the same parts as those of FIG. 5 are denoted by the same marks as those of FIG. 5, and their descriptions are omitted.

As shown in FIG. 9, the magnification variation section 300 is equipped with the pixel insertion section 310 and the reset signal generation section 320.

The pixel insertion section 310 is equipped with the main scan counter 311, the HV & VV section 312, the timing adjustment section 313, the line buffer 314, the random number generation section 315, the sub-scan counter 316, the selection signal generation section 317a, the selection section 318a, and a linear interpolation section 319.

The selection signal generation section 317a receives of the inputs of a pixel counter value from the main scan counter 311, an initial phase value from the random number generation section 315, a line counter value from the sub-scan counter 316, and an insertion period signal from the control section 100. The selection signal generation section 317a compares the line counter value (CNT) and the initial phase value on the basis of the input pixel counter value, the initial phase value, the line counter value, and the insertion period signal. Then, the selection signal generation section 317a generates a selection signal FLG indicating whether to select the image data stored in the line buffer 314 or not according to the comparison result, and outputs the selection signal FLG to the selection section 318a.

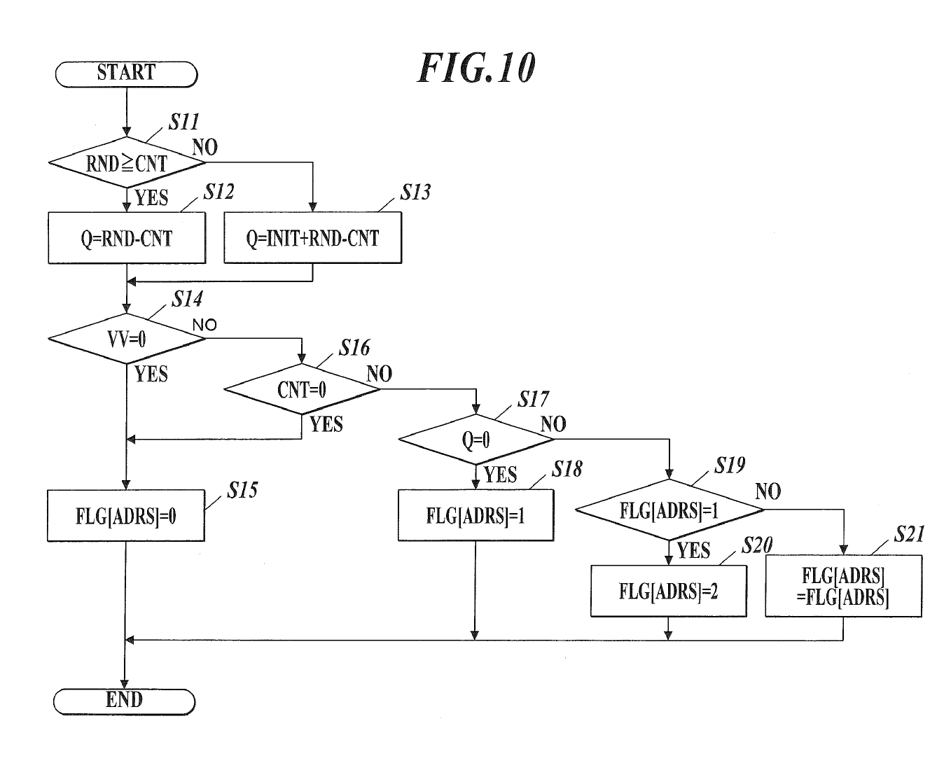

FIG. 10 shows the flow chart of the selection signal generation processing executed by the selection signal generation section 317a. In addition, the selection signal generation processing shown in FIG. 10 is executed every input of a pixel counter value ADRS.

Because the processing at Steps S11-S18 shown in FIG. 10 is similar to the processing at Steps S1-S8 shown in FIG. 6, the description of the processing is omitted.

If the variable Q is not zero (Step S17: NO), the selection signal generation section 317a judges whether the selection signal FLG [ADRS] of the input pixel counter value ADRS is one or not (Step S19).

If the selection signal FLG [ADRS] of the input pixel counter value ADRS is one (Step S19: YES), the selection signal generation section 317a sets the selection signal FLG [ADRS] to two (Step S20), and ends the selection signal generation processing.

If the selection signal FLG [ADRS] of the input pixel counter value ADRS is not one (Step S19: NO), the selection signal generation section 317a keeps the selection signal FLG [ADRS] to the set selection signal FLG (Step S21), and ends the selection signal generation processing.

The linear interpolation section 319 receives the inputs of the image data read-out from the image memory, and the image data (delayed image data) output from the line buffer 314. The linear interpolation section 319 generates the average image data of the image data and the delayed image data of each pixel corresponding to the pixel counter value, and outputs the average image data to the selection section 318a.

In addition, although the present embodiment is configured to be equipped with one line buffer 314, it is also possible to configure the linear interpolation section to be equipped with a plurality of line buffers to perform the smoothing of an insertion position by using predetermined interpolation processing, such as the bicubic method.

The selection section 318a receives the inputs of the image data (input image data) read-out from the image memory, the image data (delayed image data) output from the line buffer 314, the average image data generated by the linear interpolation section 319, and the selection signal generated by the selection signal generation section 317a.

The selection section 318a selects any one of the input image data input from the image memory, the delayed image data input from the line buffer 314, and average image data input from the linear interpolation section 319 according to an input selection signal to each pixel corresponding to the pixel counter value.

The selection section 318a of the present embodiment is set to select the input image data when the selection signal is zero, to select the average image data when the selection signal is one, and to select the delayed image data when the selection signal is two.

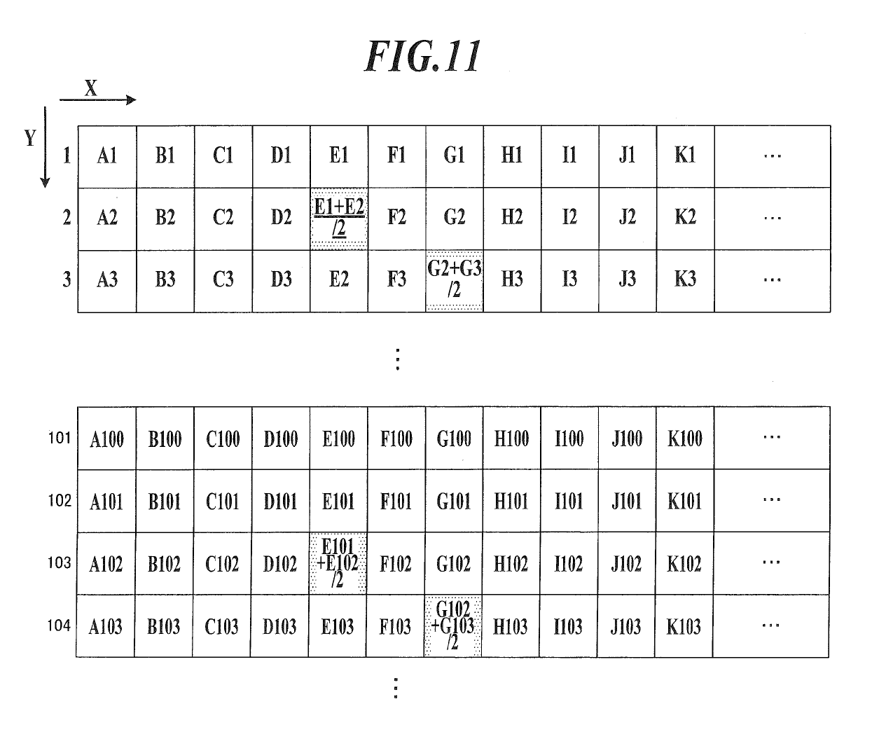

FIG. 11 shows a partially expanded image diagram of the output image based on output image data when the multiple-value image data is expanded in the sub-scan direction.

The marks shown in FIG. 11 are ones for identifying the respective pixels shown in FIGS. 7A-7E, and the line numbers of an output image are shown in the sub-scan direction Y. Each of the pixels subjected to half-tone dot meshing shows the pixel at which an average value of the pixel values of the pixels before and behind the pixel in the sub-scan direction Y.

As shown in FIG. 11, the insertion of pixels in adjacent pixel trains in the sub-scan direction Y is performed at positions that are discontinuous in the main scan direction X, and the insertion of a pixel is executed at each insertion period. This is because the initial phase values generated by the random number generation section 315 are different at every pixel counter value and the initial phase of the insertion period of a pixel train in the pixel sub-scan direction Y is different from those of the insertion periods of the other pixel trains in the sub-scan direction Y.

Next, the case of reducing image data in the sub-scan direction will be described.

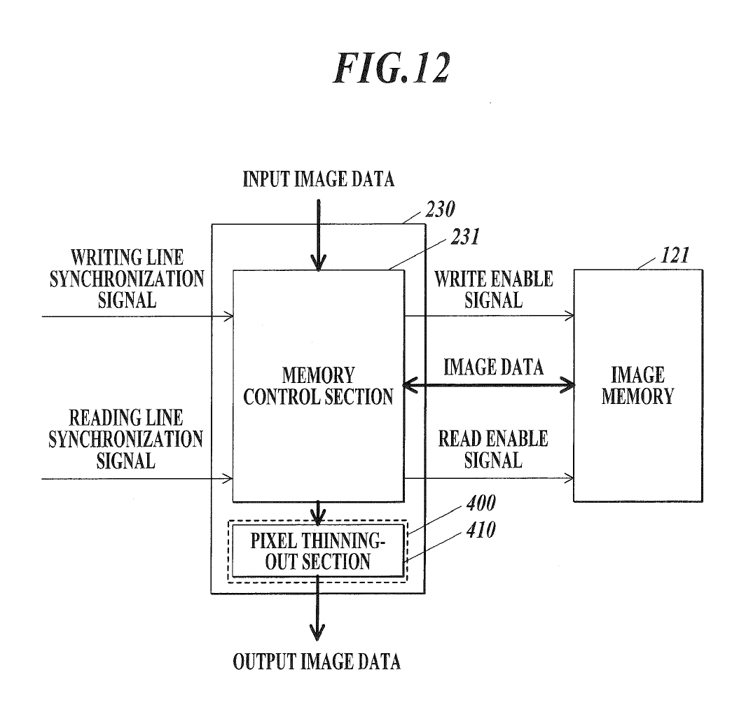

FIG. 12 shows the schematic functional configuration diagram of the memory controller 230 in the case of reducing image data into the sub-scan direction. As shown in FIG. 12, the memory controller 230 is equipped with a memory control section 231 and a magnification variation section 400.

In addition, the pars similar to those of FIG. 4 are denoted by the same marks as those of FIG. 4, and their descriptions are omitted.

The magnification variation section 400 is provided at the position of an input/output section of image data to the image memory 121 in the memory controller 230, and is equipped with a pixel thinning-out section 410. The magnification variation section 400 stops the output of the read enable signal, and performs the thinning-out of a pixel in each pixel train in the sub-scan direction.

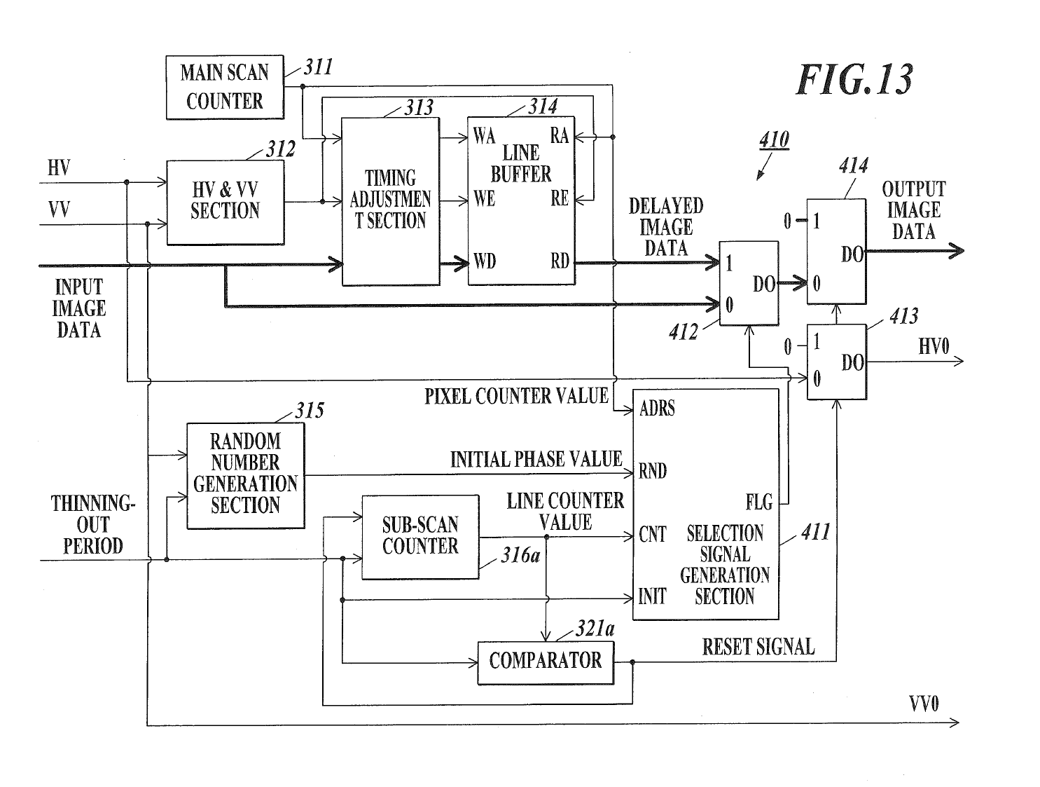

FIG. 13 shows a schematic configuration diagram of the pixel thinning-out section 410 shown in FIG. 12.

As shown in FIG. 13, the pixel thinning-out section 410 is equipped with the main scan counter 311, the HV & VV section 312, the timing adjustment section 313, the line buffer 314, the random number generation section 315, a sub-scan counter 316a, a comparator 321a, a selection signal generation section 411, a first selection section 412, an HV thinning-out section 413, and a second selection section 414.

In addition, the same parts as those of FIG. 5 are denoted by the same marks as those of FIG. 5, and their descriptions are omitted.

The sub-scan counter 316a is a counter generating a clock signal and counting the number of pixels in a thinning-out period in the sub-scan direction from one on the basis of a magnification variation ratio.

The sub-scan counter 316a receives the input of an thinning-out period signal from the control section 100 and the input of a reset signal from the comparator 321, and outputs a counter value (line counter value: CNT) of the number of pixels in the thinning-out period to the selection signal generation section 411 and the comparator 321a. Moreover, when a reset signal is input into the sub-scan counter 316a, the sub-scan counter 316a resets the line counter value.

The comparator 321a receives the input of a thinning-out period signal from the control section 100 and the input of a line counter value from the sub-scan counter 316. The comparator 321 compares the thinning-out period and the line counter value, and generates a reset signal according to a comparison result. The comparator 321 outputs the reset signal to the sub-scan counter 316a and the HV thinning-out section 413, and functions as an input/output control section to control the input and output of image data in the main scan direction.

The selection signal generation section 411 receives the inputs of a pixel counter value from the main scan counter 311, an initial phase value from the random number generation section 315, a line counter value from the sub-scan counter 316, and a thinning-out period signal from the control section 100. The selection signal generation section 411 compares the line counter value (CNT) and the initial phase value on the basis of the input pixel counter value, the initial phase value, the line counter value, and the thinning-out period signal, and generates a selection signal FLG indicating whether to select the image data stored in the line buffer 314 or not according to the comparison result to output the selection signal FLG to the first selection section 412.

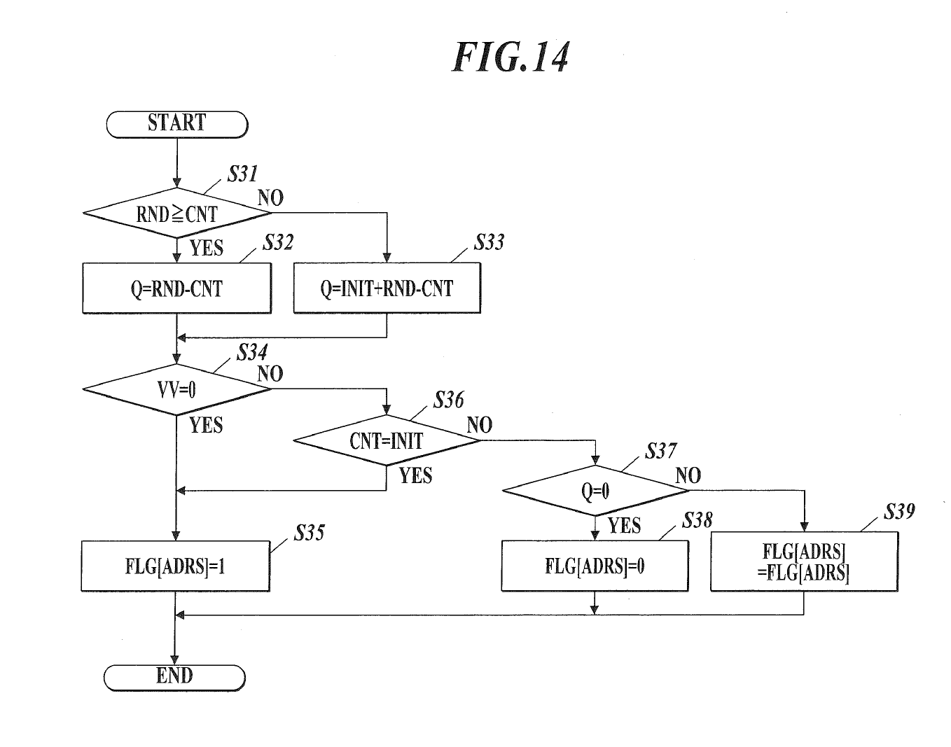

FIG. 14 shows the flow chart of the selection signal generation processing executed by the selection signal generation section 411. In addition, the selection signal generation processing shown in FIG. 14 is executed every input of a pixel counter value ADRS.

Because the processing at Steps S31-S34 is similar to that at Steps S1-S4 shown in FIG. 6, the description thereof is omitted.

If the VV signal is zero, that is, if the pixel is out of the imaging region (Step S34: YES), the selection signal generation section 411 sets the selection signal FLG [ADRS] of the input pixel counter value ADRS to one (Step S35), and the selection signal generation section 411 ends the selection signal generation processing.

If the VV signal is not zero, that is, if the VV signal is one (Step S34: NO), the selection signal generation section 411 judges that the pixel is within the imaging region, and the selection signal generation section 411 judges whether the line counter value CNT is equal to the thinning-out period INIT or not (Step S36). If the line counter value CNT is equal to the thinning-out period INIT (Step S36: YES), the selection signal generation section 411 executes the processing at Step S35.

If the line counter value CNT is not equal to the thinning-out period INIT (Step S36: NO), the selection signal generation section 411 judges whether the variable Q is zero or not (Step S37). If the variable Q is zero (Step S37: YES), the selection signal generation section 411 sets the selection signal FLG [ADRS] of the input pixel counter value ADRS to zero (Step S38), and the selection signal generation section 411 ends the selection signal generation processing.

If the variable Q is not zero (Step S37: NO), the selection signal generation section 411 keeps the selection signal FLG [ADRS] of the input pixel counter value ADRS to the set selection signal (Step S39), and the selection signal generation section 411 ends the selection signal generation processing.

The first selection section 412 receives the inputs of the image data read-out from the image memory, the image data (delayed image data) output from the line buffer 314, and the selection signal generated by the selection signal generation section 411. The first selection section 412 selects and outputs any one of the image data input from the image memory and the delayed image data input from the line buffer 314 according to an input selection signal to each pixel corresponding to the pixel counter value.

The first selection section 412 of the present embodiment is set to select the image data when the selection signal is zero, and to select the delayed image data when the selection signal is one.

The HV thinning-out section 413 receives the inputs of an HV signal and a reset signal from the comparator 321.

The HV thinning-out section 413 thins out the output timing of an HV signal for one line according to a reset signal, that is, the HV thinning-out section 413 generates a signal (HV zero signal) for making the HV signal “zero” for one line to output the HV zero signal to the second selection section 414 and the output image processing section 240.

The second selection section 414 receives the input of the image data (input image data/delayed image data) selected by the first selection section 412 and the input of the HV zero signal generated by the HV thinning-out section 413. The second selection section 414 outputs the input image data to the output image data processing section 240 as output image data in accordance with the HV zero signal.

Moreover, the VV signal is output to the output image processing section 240 as a VV zero signal.

In addition, although the pixel thinning-out section 410 is configured to set the horizontal image valid signal (HV signal) as the signal of a thinning-out object, the pixel thinning-out section 410 may be configured to thin out the HV signal together with a horizontal synchronization signal, or may be configured to generate a signal indicating the thinning-out object line to transmit the signal to an image processing section situated downstream.

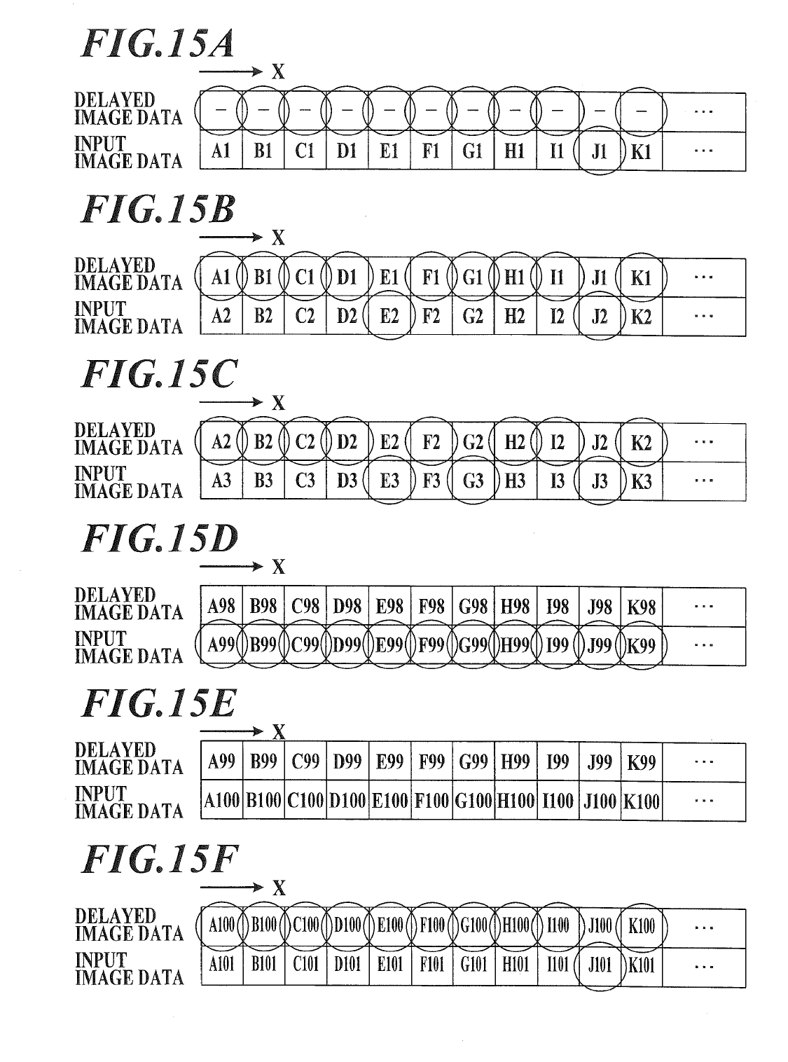

FIGS. 15A-15F show operation image diagrams of output image data when image data is reduced into the sub-scan direction.

FIGS. 15A-15F show the delayed image data for one line output from the line buffer 314 to the first selection section 412, and the input image data for one line output from the image memory to the first selection section 412. A, B, C, . . . shown in FIGS. 15A-15F are identification marks of the pixels in the main scan direction, and 1, 2, 3, . . . are identification marks (line numbers) of the pixels in the sub-scan direction. The pixels enclosed by circles indicate the pixels selected by the first selection section 412 and to be output from the second selection section 414 as output image data.

FIG. 15A shows an operation image diagram of the output image data when the line counter value is one. As shown in FIG. 15A, because the line buffer 314 is in the state of having no delayed image data therein, no delayed image data is output from the line buffer 314 (denoted by “-” in FIG. 15A). The input image data at a first line is output from the image memory.

For example, if the pixel counter value is J, the initial phase value is one, and the line counter value is one, then the selection signal FLG is set to zero to the pixel counter value J, and a pixel J1 of the input image data at the first line is led to be selected as the pixel J of the output image data at the first line.

FIG. 15B shows an operation image diagram of the output image data when the line counter value is two. As shown in FIG. 15B, the input image data at the first line is output from the line buffer 314, and the input image data at a second line is output from the image memory.

For example, if the pixel counter value is E, the initial phase value is two, and the line counter value is two, then the selection signal FLG is set to zero to the pixel counter value E. A pixel E2 of the input image data (input image data at the second line) is led to be selected as the pixel E of the output image data at the second line. Here, by the selection of the image data (E2) at the second line as the pixel E of the output image data at the second line, the pixel E1 of the input image data at the first line is thinned out to be led not to be output, and the column of the pixel E results in being thinned out by one pixel in the sub-scan direction.

In addition, because the selection signal FLG to the pixel counter value J is kept, the pixel J2 of the input image data (input image data at the second line) is led to be selected as the pixel J of the output image data at the second line.

Moreover, because the selection signals FLG to the pixel counter values excluding the pixels E and J are kept, the pixels of the delayed image data (the input image data at the first line) output from the line buffer 314 are led to be selected as the pixels of the output image data excluding the E and J at the second line.

FIG. 15C shows the operation image diagram of the output image data in the case where the line counter value is three. As shown in FIG. 15C, the input image data at the second line is output from the line buffer 314, and the input image data at a third line is output from the image memory.

For example, if the pixel counter value is G, the initial phase value is three, and the line counter value is three, then the selection signal FLG is set to zero to the pixel value G, and the pixel G3 of the input image data (the input image data at the third line) is led to be selected as the pixel G of the output image data at the third line. Here, by the selection of the pixel G3 of the input image data at the third line as the pixel G of the output image data at the third line, the pixel G2 of the input image data at the second line is led to be thinned out not to be output, and the column of the pixel G is led to be thinned out by one pixel in the sub-scan direction.

In addition, because the selection signals FLG to the pixel counter values E and J are kept, the pixels E3 and J3 of the input image data (the input image data at the third line) are led to be selected as the pixels E and J of the output image data at the third line.

Moreover, because the selection signals FLG to the pixel counter values of the pixels excluding the pixels E, G, and J are kept, the pixels of the delayed image data (input image data at the second line) output from the lien buffer 314 are led to be selected as the pixels excluding the E, G, and J of the output image data at the third line.

After that, the pixels selecting the input image data output from the image memory increase line by line.

FIG. 15D shows an operation image diagram of the output image data when the line counter value is 99. As shown in FIG. 15D, the input image data at the 98^{th} line is output from the line buffer 314, and the input image data at the 99^{th} line is output from the image memory.

Here, the pixels of the input image data (input image data at the 99^{th} line) output from the image memory are led to be selected as the pixels of the output image data at the 99^{th} line. Consequently, all the pixel trains in the sub-scan direction excluding the J column are led to be thinned out by one pixel in the sub-scan direction.

FIG. 15E shows an operation image diagram of output image data when the line counter value is equal to the thinning-out period (for example, 100). As shown in FIG. 15E, the input image data at the 99^{th} line is output from the line buffer 314, and the input image data at the 100^{th} line is output from the image memory.

Because the line counter value is equal to the thinning-out period, the selection signals FLG to all the pixel counter values are set to “one,” and the pixels of the input image data at the 99^{th} line are selected as all the pixels in the first selection section. On the other hand, when the line counter value becomes equal to the thinning-out period (for example, 100), a reset signal is input from the comparator 321 into the HV thinning-out section 413, and the HV zero signal is input from the HV thinning-out section 413 to the second selection section 414. Consequently, because the HV zero signal is input into the second selection section 414, the image data of the line buffer 314 or the image memory is not selected, and the output of the image data for one line is stopped.

Moreover, when the line counter value becomes equal to the thinning-out period (for example, 100), a reset signal is input into the sub-scan counter, and the line counter value is reset.

FIG. 15F shows an operation image diagram of output image data when the line counter value is reset (the case where the line counter value is one) after the processing of FIG. 15E. As shown in FIG. 15F, the input image data at the 100^{th} line is output from the line buffer 314, and the input image data at the 101^{st} line is output from the image memory.

For example, if the pixel counter value is J, the initial phase value is one, and the line counter value is one, then the selection signal FLG is set to one to the pixel counter value J, and the pixel J101 of the input image data at the 101^{st} line output from the image memory is led to be selected as the pixel J of the output image data at the 100^{th} line. By the selection of the pixel J101 of the input image data at the 101^{st} line as the pixel J of the output image data at the 100^{th} line, the pixel J100 at the 100^{th} line of the input image data at the 100^{th} line is led to be thinned out not to be output, and the pixel J column is led to be thinned out by one pixel in the sub-scan direction at this stage.

In addition, because the selection signals FLG to the other pixel counter values are kept, the delayed image data (the input image data at the 100^{th} line) output from the line buffer 314 is led to be selected as the pixels of the output image data at the 100^{th} line excluding the pixel J.

After that, the operations as shown in FIGS. 15B-15E are repeated.

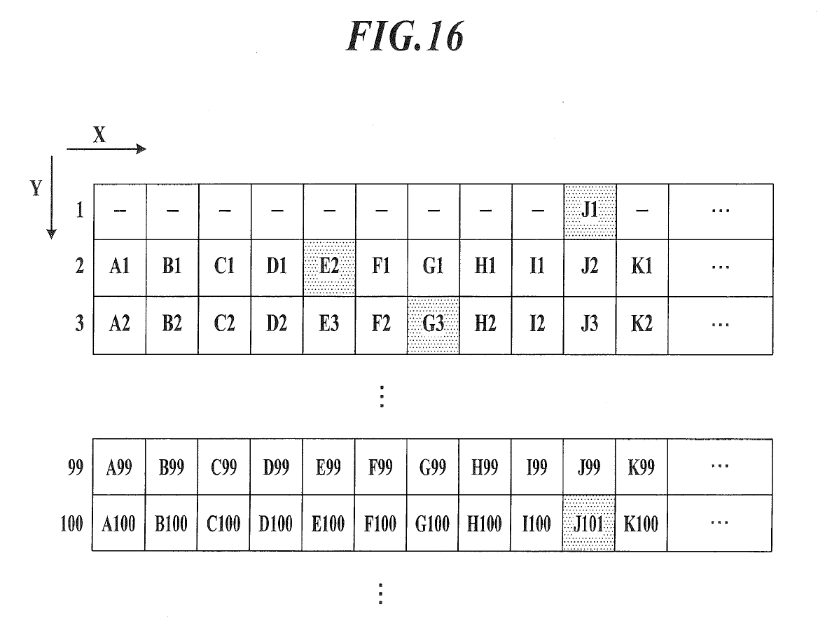

FIG. 16 shows a partially expanded image diagram of the output image based on output image data when the image data is reduced in the sub-scan direction shown in FIGS. 15A-15F.

The marks shown in FIG. 16 are ones for identifying the respective pixels shown in FIGS. 15A-15F, and the line numbers of an output image are shown in the sub-scan direction Y. Each of the pixels subjected to half-tone dot meshing shows the state in which the preceding pixel in the sub-scan direction Y is thinned out by one.

As shown in FIG. 16, the thinning-out of pixels in adjacent pixel trains in the sub-scan direction Y is performed at positions that are discontinuous in the main scan direction X, and the thinning-out is executed at each thinning-out period. This is because the initial phase values generated by the random number generation section 315 are different at every pixel counter value and the initial phase of the thinning-out period of a pixel train in the sub-scan direction Y is different from those of the thinning-out periods of the other pixel trains in the sub-scan direction Y.

Although the case where the magnification variation section 400 to be used in the case of reducing image data in the sub-scan direction is provided in the memory controller 230 has been described, the present invention is not limited to this configuration, but the magnification variation section 400 may be provided in the output image memory controller 250.

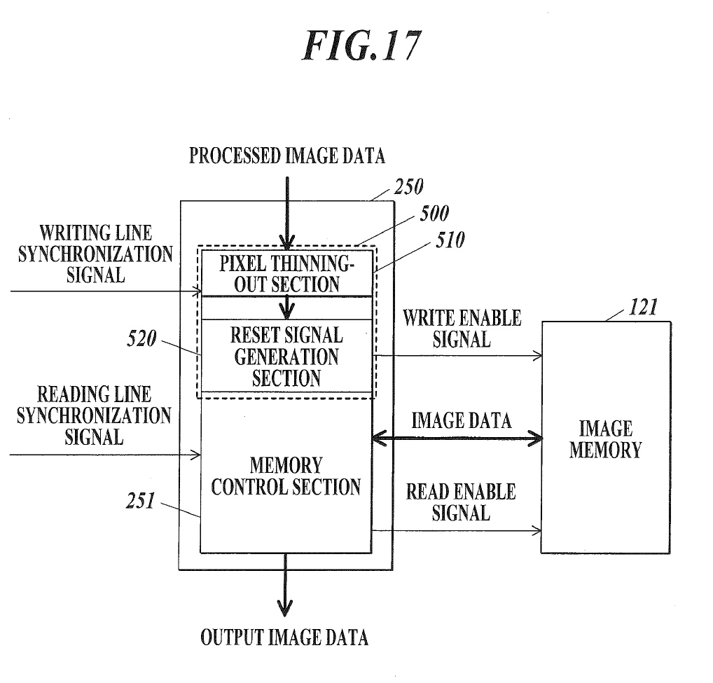

FIG. 17 shows a schematic functional configuration diagram of the output image memory controller 250 in the case of reducing image data in the sub-scan direction.

As shown in FIG. 17, the output image memory controller 250 is equipped with a memory control section 251 and a magnification variation section 500.

In addition, the parts similar to those of FIG. 12 are denoted by the same marks as those in FIG. 4, and their descriptions are omitted.

The magnification variation section 500 is provided at a position of the input/output section of image data to the output image memory 122 in the output image memory controller 250. The magnification variation section 500 is equipped with a pixel thinning-out section 510 and a reset signal generation section 520. The magnification variation section 500 stops the output of a write enable signal, and performs the thinning-out of a pixel to each pixel train in the sub-scan direction.

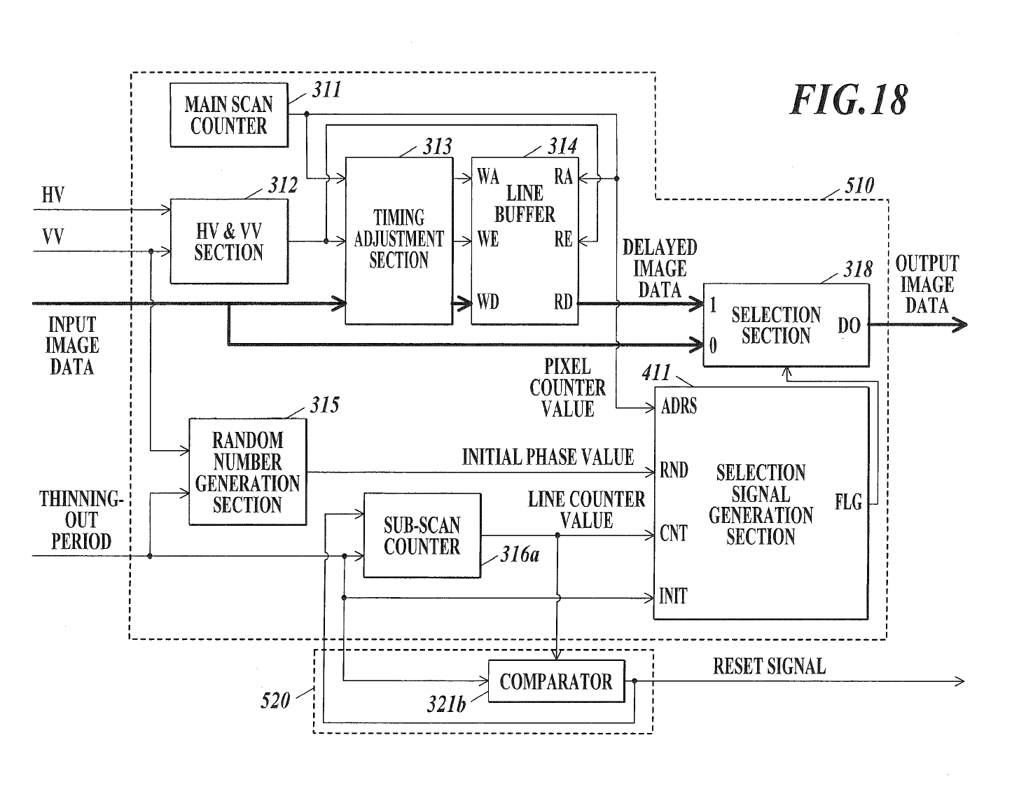

FIG. 18 shows a schematic configuration diagram of the magnification variation section 500 shown in FIG. 17.

As shown in FIG. 18, the magnification variation section 500 is equipped with the pixel thinning-out section 510 and the reset signal generation section 520

The pixel thinning-out section 510 is equipped with the main scan counter 311, the HV & VV section 312, the timing adjustment section 313, the line buffer 314, the random number generation section 315, the sub-scan counter 316a, the selection signal generation section 411, and the selection section 318.

The reset signal generation section 520 is equipped with a comparator 321b.

In addition, the parts similar to those of FIGS. 5 and 12 are denoted by the same marks as those of FIGS. 5 and 12, and their descriptions are omitted.

The comparator 321b receives the inputs of a thinning-out period signal from the control section 100 and a line counter value from the sub-scan counter 316a. The comparator 321b compares the thinning-out period and the line counter value, and generates a reset signal according to the comparison result. The comparator 321b outputs the reset signal to the output image memory 122 and the sub-scan counter 316a, and functions as an input/output control section to control the input and the output of image data in the main scan direction.

When the reset signal is input into the output image memory 122, the reset signal functions as a signal for stopping the output of a write enable signal for writing image data into the output image memory every line for one line, and stops the writing-in of the image data for one line in the main scan direction into the output image memory 122. In the present embodiment, the reset signal is generated when the thinning-out period and the line counter value are equal to each other.

As described above, according to the present embodiment, when a magnification variation is performed by the insertion or the thinning-out of a pixel to each pixel train in the sub-scan direction on the basis of a magnification variation ratio, the insertion or the thinning-out of pixels in adjacent pixel trains in the sub-scan direction is performed at positions that are discontinuous in the main scan direction. Thereby, a magnification ratio adjustment (expansion or reduction) of image data in the sub-scan direction can be performed without changing the rotation speed of a polygon mirror, and the image deterioration accompanying the magnification ratio adjustment can be prevented to be able to improve productivity.

Furthermore, because the insertion or the thinning-out of a pixel can be performed to each pixel train in the sub-scan direction at a period (magnification variation period) in the sub-scan direction calculated on the basis of a magnification variation ratio, the continuous insertion or the thinning-out of pixels in the sub-scan direction can be prevented, and the deterioration of image quality accompanying the adjustment of the magnification variation of image data can be reduced. Moreover, because the phase of the periodic pattern of the insertion or the thinning-out of a pixel implemented at a period in the sub-scan direction is different from each other at each pixel train in the sub-scan direction, continuous insertion or thinning-out of pixels in the main scan direction can be prevented, and the deterioration of image quality accompanying the adjustment of the magnification variation of image data can be reduced.

Furthermore, a random number generated by the random number generation section 315 can be used as an initial phase value of a period of a periodic pattern to each pixel train in the sub-scan direction, and the continuous insertion or the thinning-out of pixels in the main scan direction can be prevented. Thereby, the deterioration of image quality accompanying the adjustment of the magnification variation of image data can be reduced.

Moreover, even if an initial phase storage section is provided in place of the random number generation section 315, the initial phase value of a period in the sub-scan direction can be set to each pixel train in the sub-scan direction by using the initial phase setting information stored in the initial phase storage section, and the continuous insertion or the thinning-out of pixels in the main scan direction can be prevented. Thereby, the deterioration of image quality accompanying the adjustment of the magnification variation of image data can be reduced.

Furthermore, the magnification variation section is provided at a position of the input/output section of image data to the image memory 121 or the output image memory 122 in the memory control section, and thereby the output of enabling signals (write enable signal and read enable signal) generated by the memory control section can directly be stopped. Consequently, the insertion or the thinning-out of a pixel can be performed.

Furthermore, because screen processing can be performed after performing the magnification ratio adjustment (expansion or reduction) of image data in the sub-scan direction by performing insertion or thinning-out of a pixel to the image data after rasterization, the deterioration of image quality accompanying the adjustment of a magnification ratio can be reduced.

Furthermore, the insertion or the thinning-out of a pixel can be performed by using the nearest neighbor processing or predetermined interpolation processing to each pixel train in the sub-scan direction, and consequently the fall of image quality can be reduced.

Moreover, the input of image data in the main scan direction can be stopped at the time of the insertion of a pixel, and the output of image data in the main scan direction can be stopped at the time of the thinning-out of a pixel by means of a reset signal output according to a comparison result of a period in the sub-scan direction and a line counter value.

Furthermore, if the magnification variation section is connected downstream of the memory control section, any one of, or both of a horizontal synchronization signal and a horizontal image valid signal (HV signal) can be made to be inactive together with image data by an HV zero signal output at the time of stopping the output of image data in the main scan direction at the time of the thinning-out of a pixel, and consequently the thinning-out of a pixel can be performed.

Furthermore, a magnification variation section functioning as an expansion section to perform the insertion processing of a pixel can be connected downstream of the memory control section, and a magnification variation section functioning as a reduction section to perform the thinning-out processing of a pixel can be connected upstream of the memory control section.

Moreover, a magnification ratio adjustment (expansion or reduction) in the sub-scan direction can individually be performed on the basis of the magnification variation ratios individually set to the front surface and the back surface of a sheet of paper to the imaged data formed as an image on the front surface of the paper and the image data formed as an image on the back surface of the paper without changing the rotation speed of a polygon mirror. In particular, the accuracy of front-back registration for according the positions of the images, formed on both the sides of a sheet of paper, on the front surface and the back surface of the sheet of paper can be heightened and productivity can be improved at the time of performing the front-back registration.

Furthermore, because the magnification variation ratio set to each type and size of each sheet of paper can be used, the magnification ratio adjustment in the sub-scan direction corresponding to heat shrinkage rates different from each other according to the type and size of the sheets of paper can be performed.

Moreover, the present invention is not limited to the contents of the aforesaid embodiment, and can suitably be changed without departing from the sprit and scope of the present invention.

According to an aspect of a preferable embodiment of the present invention, there is provided an image processing apparatus 200, including a magnification variation section 300, 400 or 500 to perform a magnification variation by insertion or thinning-out of a pixel in a pixel train in a sub-scan direction Y based on a set magnification variation ratio to image data configured by arranging a plurality of lines in the sub-scan direction Y perpendicular to a main scan direction X, in which a pixel train arranged as one of the plurality of lines, wherein the magnification variation section 300, 400 or 500 performs the insertion or the thinning-out of pixels in adjacent pixel trains in the sub-scan direction Y at positions that are discontinuous in the main scan direction X.

This image processing apparatus 200 can perform a magnification ratio adjustment of image data in the sub-scan direction Y and can prevent the image deterioration accompanying the magnification ratio adjustment to enable the improvement of productivity without changing the rotation speed of a polygon mirror.

Preferably, the magnification variation section 300, 400 or 500 performs the insertion or the thinning-out of a pixel in each pixel train in the sub-scan direction Y in a period of the sub-scan direction Y calculated based on the magnification variation ratio.

Furthermore, it can be prevented that pixels are continuously subjected to the insertion or the thinning-out in the sub-scan direction Y, and the deterioration of image data can be reduced.

Preferably, a phase of a periodic pattern of the insertion or the thinning-out of a pixel implemented in the period of the sub-scan direction Y is different in each pixel train in the sub-scan direction Y.

Furthermore, it can be prevented that pixels are continuously subjected to the insertion or the thinning-out in the main scan direction X, and the deterioration of image data can be reduced.

Preferably, the magnification variation section 300, 400 or 500 includes an initial phase storage section to store initial phase setting information indicating an initial phase value of the periodic pattern in each pixel train of the sub-scan direction Y.

Furthermore, it is possible to set the initial phase value of the periodic pattern to each pixel train in the sub-scan direction Y by using the initial phase setting information stored in the initial phase storage section, and it can be prevented that pixels are continuously subjected to the insertion or the thinning-out in the main scan direction X to enable the reduction of the deterioration of image data.

Preferably, the magnification variation section 300, 400 or 500 includes a random number generation section 315 to generate a random number within a range of the period of the sub-scan direction Y to each pixel train of the sub-scan direction Y, and the random number generated by the random number generation section 315 is set as the initial phase value of the periodic pattern to each pixel train of the sub-scan direction Y.

Furthermore, it is possible to set the random number generated by the random number generation section 315 as the initial phase value of the periodic pattern to each pixel train in the sub-scan direction Y, and it can be prevented that pixels are continuously subjected to the insertion or the thinning-out in the main scan direction X to enable the reduction of the deterioration of image data.

Preferably, the image processing apparatus 200 further includes: an image memory 121 to store the image data; and a memory control section 231 to generate an enable signal enabling the image memory to perform input or output of the image data, and to control the input or the output of the image data to the image memory 121 based on output of the enabling signal, wherein the magnification variation section 300, 400 or 500 is provided at a position of an input/output section of the image data to the image memory in the memory control section 231, and stops the output of the enabling signal to perform the insertion or the thinning-out of a pixel.

Furthermore, by the provision of the magnification variation section 300, 400 or 500 at the position of the input/output section of image data to the image memory 121 in the memory control section 231, the output of the enabling signal generated by the memory control section 231 can directly be stopped, and the insertion or the thinning-out of a pixel can be performed.

Preferably, the image processing apparatus 200 further includes: a rasterization section 220 to rasterize the image data; and a screen processing section 240 to perform screen processing to the image data, wherein the magnification variation section 300, 400 or 500 is provided at a subsequent stage of the rasterization section 220 and a preceding stage of the screen processing section 240, the magnification variation section 300, 400 or 500 receiving input of the image data rasterized by the rasterization section 220, the magnification variation section 300, 400 or 500 outputting the image data to the screen processing section 240.

Furthermore, by the provision of the magnification variation section 300, 400 or 500 at the position of the input/output section of image data to the image memory 121 in the memory control section 231, the output of the enabling signal generated by the memory control section 231 can directly be stopped, and consequently the insertion or the thinning-out of a pixel can be performed.

Preferable, the magnification variation section 300, 400 or 500 performs the insertion or thinning-out of a pixel using nearest neighbor processing to a pixel train in the sub-scan direction Y.

Furthermore, the insertion or the thinning-out of a pixel can be performed by using the nearest neighbor processing to a pixel train in the sub-scan direction Y.

Preferably, the magnification variation section 300, 400 or 500 performs smoothing of an insertion position or a thinning position of a pixel using predetermined interpolation processing to a pixel train of the sub-scan direction Y.

Furthermore, the smoothing of an insertion position or a thinning-out position of a pixel can be performed by using the predetermined interpolation processing to a pixel train in the sub-scan direction Y, and the deterioration of image data can be reduced.

Preferably, the magnification variation section 300, 400 or 500 includes: a buffer 314 to temporarily store image data of a pixel train of the main scan direction X preceding input image data of the main scan direction X by one train in the sub-scan direction Y; a main scan counter 311 to count a number of pixels in the main scan direction X; an initial phase output section 315 to output an initial phase value of the periodic pattern to each pixel train of the sub-scan direction Yin synchronization with the main scan counter 311; a sub-scan counter 316 or 316a to count the number of pixels in the period of the sub-scan direction Y based on the magnification variation ratio; a selection signal generation section 317, 317a or 411 to generate a selection signal indicating whether to select the image data stored in the buffer 314 or not according to a comparison result of a counter value by the sub-scan counter 316 or 316a and the initial phase value to each pixel corresponding to a counter value by the main scan counter 311; a selection section 318 or 318a to select and output one piece of the input image data of the pixel train in the main scan direction X and the image data of the pixel train in the main scan direction X stored in the buffer 314 according to the selection signal generated by selection signal generation section 317, 317a or 411 to each pixel corresponding to the counter value by the main scan counter 311; and an input/output control section 321 or 321a to compare the period of the sub-scan direction Y and the counter value by the sub-scan counter 316 or 316a, and to control input and output of the image data in the main scan direction X according to the comparison result.

Furthermore, it can be prevented that pixels are continuously subjected to the insertion or the thinning-out in the main scan direction X, and the deterioration of image data can be reduced.

Preferably, the input/output control section 321 or 321a stops the input of the image data in the main scan direction X at a time of the insertion of a pixel, and stops the output of the image data in the main scan direction X at a time of the thinning-out of a pixel, according to the comparison result.

Furthermore, it is possible to stop the input of the image data in the main scan direction X at the time of the insertion of a pixel and the output of the image data in the main scan direction X at the time of the thinning-out of a pixel.

Preferably, the image processing apparatus 200 further includes: an image memory 121 to temporarily store the image data; and a memory control section 231 to control the image memory, wherein the magnification variation section 300, 400 or 500 is connected downstream of the memory control section 231, and does not activate one of, or both of, a horizontal synchronization signal and a horizontal image valid signal together with image data at a time of stopping the output of the image data in the main scan direction X at a time of the thinning-out of a pixel.

Furthermore, by the connection of the magnification variation section 300, 400 or 500 downstream of the memory control section 231, and by not activating one of, or both of, the horizontal synchronization signal and the horizontal image valid signal together with the image data at the time of stopping the output of the image data in the main scan direction X at the time of thinning-out of a pixel, the thinning-out of the pixel can be performed.

Preferably, the image processing apparatus further includes: an image memory 121 to temporarily store the image data; and a memory control section 231 to control the image memory 121, wherein an expansion section to perform insertion processing of the pixel in the magnification variation section 300, 400 or 500 is connected downstream of the memory control section 231, and a reduction section 410 or 510 to perform thinning-out processing of a pixel in the magnification variation section 300, 400 or 500 is connected upstream of the memory control section 231.

Furthermore, it is possible to connect the expansion section 310 to perform the insertion processing of a pixel downstream of the memory control section 231 and the reduction section 410 or 510 to perform the thinning-out of a pixel upstream of the memory control section 231 in the magnification variation section 300, 400 or 500.

According to another aspect of the preferable embodiment of the present invention, there is provided an image formation apparatus 1, including: an image formation section 42 to perform image formation on both sides of a sheet of paper based on image data; an storage section 111 to store magnification variation ratios individually set on a front surface and a back surface of the sheet of paper on which the image formation is performed based on the image data; and the image processing apparatus 200 described above.

This image formation apparatus 1 can perform a magnification ratio adjustment in the sub-scan direction Y individually and can improve the productivity at the time of both-side image formation to the image data formed on the front surface of a sheet of paper and the image data formed on the back surface of the sheet of paper on the basis of the magnification variation ratios individually set on the front surface and the back surface of the sheet of paper without changing the rotation speed of a polygon mirror.

Preferably the magnification variation ratios are set to each of a type and a size of the sheet of paper.

Furthermore, the magnification variation ratios set every type and size of every sheet of paper can be used.

The entire disclosure of Japanese Patent Application No. 2009-293584 filed on Dec. 25, 2009 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image processing apparatus, comprising:
a magnification variation section to perform a magnification variation to image data configured by arranging a plurality of lines in a sub-scan direction perpendicular to a main scan direction, in which a first pixel train is arranged as one of the plurality of lines, by inserting a pixel into a second pixel train in the sub-scan direction or by thinning-out a pixel from the second pixel train based on a set magnification variation ratio, wherein
the magnification variation section inserts pixels in adjacent second pixel trains at positions that are discontinuous in the main scan direction, or thin-outs pixels in adjacent second pixel trains at portions that are discontinuous in the main scan direction.

2. The image processing apparatus according to claim 1, wherein
the magnification variation section performs the insertion or the thinning-out of a pixel in each second pixel train in a period of the sub-scan direction calculated based on the magnification variation ratio.

3. The image processing apparatus according to claim 2, wherein
a phase of a periodic pattern of the insertion or the thinning-out of a pixel implemented in the period of the sub-scan direction is different in each second pixel train.

4. The image processing apparatus according to claim 3, wherein
the magnification variation section includes an initial phase storage section to store initial phase setting information indicating an initial phase value of the periodic pattern in each second pixel train.

5. The image processing apparatus according to claim 3, wherein
the magnification variation section includes a random number generation section to generate a random number within a range of the period of the sub-scan direction to each second pixel train, and
the random number generated by the random number generation section is set as the initial phase value of the periodic pattern to each second pixel train of the sub-scan direction.

6. The image processing apparatus according to claim 1, further comprising:
an image memory to store the image data; and
a memory control section to generate an enable signal enabling the image memory to perform input or output of the image data, and to control the input or the output of the image data to the image memory based on output of the enabling signal, wherein
the magnification variation section is provided at a position of an input/output section of the image data to the image memory in the memory control section, and stops the output of the enabling signal to perform the insertion or the thinning-out of a pixel.

7. The image processing apparatus according to claim 1, further comprising:
a rasterization section to rasterize the image data; and
a screen processing section to perform screen processing to the image data,
wherein the magnification variation section is provided at a subsequent stage of the rasterization section and a preceding stage of the screen processing section,
wherein the magnification variation section receiving input of the image data rasterized by the rasterization section, and
wherein the magnification variation section outputting the image data to the screen processing section.

8. The image processing apparatus according to claim 1, wherein
the magnification variation section performs the insertion or the thinning-out of a pixel using nearest neighbor processing to the second pixel train.

9. The image processing apparatus according to claim 1, wherein
the magnification variation section performs smoothing of an insertion position or a thinning position of a pixel by using predetermined interpolation processing to the second pixel train

10. The image processing apparatus according to claim 3, wherein
the magnification variation section includes:
a buffer to temporarily store image data of the first pixel train preceding input image data of the main scan direction by one train in the sub-scan direction;
a main scan counter to count the number of pixels in the main scan direction;
an initial phase output section to output an initial phase value of the periodic pattern to each second pixel train in synchronization with the main scan counter;
a sub-scan counter to count the number of pixels in the period of the sub-scan direction based on the magnification variation ratio;
a selection signal generation section to generate a selection signal indicating whether to select the image data stored in the buffer or not according to a comparison result of a counter value by the sub-scan counter and the initial phase value to each pixel corresponding to a counter value by the main scan counter;
a selection section to select and output one piece of the input image data of the first pixel train and the image data of the first pixel train stored in the buffer according to the selection signal generated by selection signal generation section to each pixel corresponding to the counter value by the main scan counter; and
an input/output control section to compare the period of the sub-scan direction and the counter value by the sub-scan counter, and to control input and output of the image data in the main scan direction according to the comparison result.

11. The image processing apparatus according to claim 10, wherein
the input/output control section stops the input of the image data in the main direction at a time of the insertion of a pixel, and stops the output of the image data in the main scan direction at a time of the thinning-out of a pixel, according to the comparison result.

12. The image processing apparatus according to claim 11, further comprising:
an image memory to temporarily store the image data; and
a memory control section to control the image memory, wherein
the magnification variation section is connected downstream of the memory control section, and does not activate one of, or both of, a horizontal synchronization signal and a horizontal image valid signal together with image data at a time of stopping the output of the image data in the main scan direction at a time of the thinning-out of a pixel.

13. The image processing apparatus according to claim 11, further comprising:
an image memory to temporarily store the image data; and
a memory control section to control the image memory,
wherein an expansion section to perform insertion processing of the pixel in the magnification variation section is connected downstream of the memory control section, and
wherein a reduction section to perform thinning-out processing of a pixel in the magnification variation section is connected upstream of the memory control section.

14. An image formation apparatus, comprising:
an image formation section to perform image formation on both sides of a sheet of paper based on image data;
a storage section to store magnification variation ratios individually set on a front surface and a back surface of the sheet of paper on which the image formation is performed based on the image data; and
the image processing apparatus according to claim 1.

15. The image formation apparatus according to claim 14, wherein
the magnification variation ratios are set to each of a type and a size of the sheet of paper.
